(19) United States
(12) Patent Application Publication
(10) Pub. No.: US 2023/0374371 A1
(43) Pub. Date: Nov. 23, 2023

(54) ENHANCING WATER CHEMISTRY FOR IMPROVED WELL PERFORMANCE

(71) Applicant: Chevron U.S.A. Inc., San Ramon, CA (US)

(72) Inventors: Wei Wang, Houston, TX (US); Wei Wei, Sugar Land, TX (US); Yula Tang, Midland, TX (US); Johannes Cornelis Visser, Midland, TX (US); David Gilbert Leach, Houston, TX (US); Haiping Lu, Sugar Land, TX (US); Stefan Kristopher Koszutski Lattimer, Midland, TX (US)

(21) Appl. No.: 18/319,884

(22) Filed: May 18, 2023

Related U.S. Application Data
(60) Provisional application No. 63/343,362, filed on May 18, 2022.

(51) Int. Cl. C09K 8/57; C09K 8/58

(52) U.S. Cl. CPC C09K 8/572; C09K 8/58

(57) ABSTRACT

A method for enhancing water chemistry at a surface for improved well performance may include testing water at the surface to identify a pH level of the water, a type of solid-generating component in the water, and an amount of a solid-generating component in the water. The method may also include identifying a type and an amount of an additive based on identifying the type and the amount of the solid-generating component, where the additive is configured to generate a solid when mixed with the water. The method may further include mixing the water and an additive at the surface to generate the solid and enhanced water, where the solid comprises at least some of the solid-generating components of the water. The enhanced water may be usable for a field operation to cause the improved well performance, and the solid may be removable from the enhanced water at the surface.

### CROSS-REFERENCE TO RELATED APPLICATIONS

This application claims priority to U.S. Provisional Patent Application Ser. No. 63/343,362 titled “Enhancing Water Chemistry For Improved Well Performance” and filed on May 18, 2022, the entire contents of which are hereby incorporated herein by reference.

### TECHNICAL FIELD

The present application is related to subterranean field operations and, more particularly, to enhancing water chemistry for improved well performance.

### BACKGROUND

Produced water from subterranean field operations may contain one or more different types of solid-generating components. For example, produced water may include various levels of multi-valent cations (for example, Ca²⁺, Ba²⁺, Mg²⁺, Fe³⁺, Sr²⁺, etc.). These multi-valent cations are examples of what may be found in produced water. Similarly, water from other sources may include solid-generating components. When produced water and/or water from other sources is reused in the subterranean field operations, such as during fracturing, the water may be incompatible with the chemicals used in those subterranean field operations. In other cases, as when produced water and/or water from other sources is injected into a saltwater disposal (SWD) well, the solid-generating components (e.g., multi-valent cations) in the water may cause scale and/or other solid depositions to develop and accumulate. As a result, over time, flow channels within the SWD well become congested, causing the SWD well to be underutilized and/or causing more energy (e.g., higher pressure) to be used to continue utilizing the SWD well.

### SUMMARY

In general, in one aspect, the disclosure relates to a method for enhancing water chemistry at a surface for improved well performance. The method may include testing water at the surface to identify a pH level of the water, a type of solid-generating component in the water, and an amount of a solid-generating component in the water. The method may also include identifying a type and an amount of an additive based on identifying the type and the amount of the solid-generating component, where the additive is configured to generate a solid when mixed with the water. The method may further include mixing, at the surface, the water and the additive to generate the solid and enhanced water, where the solid comprises at least some of the solid-generating components of the water. The enhanced water may be usable for a field operation to cause the improved well performance. The enhanced water may include a reduced amount of solid-generating components relative to the water. The solid may be removable from the enhanced water at the surface.

In another aspect, the disclosure relates to a system for enhancing water chemistry for improved well performance. The system may include a water source that includes water. The system may also include an additive source that includes an additive, where the additive is configured to generate a solid when mixed with the water. The system may further include a plurality of sensor devices configured to measure, at a surface, a pH level of the water, a type of solid-generating component in the water, and an amount of a solid-generating component in the water. The system may also include a mixing apparatus that is configured to receive the water and the additive at the surface, where the additive is of a type and an amount based on identifying the type and the amount of the solid-generating component in the water. The mixing apparatus may also be configured to mix the water and the additive at the surface to generate the solid and enhanced water, where the solid includes at least some solid-generating components of the water, where the enhanced water is usable for a field operation to cause the improved well performance, where the enhanced water comprises a reduced amount of solid-generating components relative to the water, and where the solid is removable from the enhanced water. The mixing apparatus may further be configured to provide access to the solid and the enhanced water.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIGS. 1A through 1D show field systems, and details thereof, with which example embodiments may be used.

FIG. 2 shows the detail of FIG. 1C at a subsequent point in time according to certain example embodiments.

FIG. 3 shows the detail of FIG. 2 at a subsequent point in time according to certain example embodiments.

FIG. 4 shows a diagram of a system for enhancing water chemistry for improved well performance according to certain example embodiments.

FIG. 5 shows a system diagram of a controller according to certain example embodiments.

FIG. 6 shows a computing device in accordance with certain example embodiments.

FIG. 7 shows a flowchart of a method for enhancing water chemistry for improved well performance according to certain example embodiments.

FIG. 8 shows a diagram of a specific application of a process flow for enhancing water chemistry for improved well performance according to certain example embodiments.

FIG. 9 shows a diagram of another specific application of a process flow for enhancing water chemistry for improved well performance according to certain example embodiments.

### DETAILED DESCRIPTION

The example embodiments discussed herein are directed to systems, apparatus, methods, and devices for enhancing water chemistry for improved well performance. In some cases, as in fields with high levels of H₂S and CO₂, example embodiments may be used to remove acidic gas and so reduce corrosion caused by the acidic gas. By enhancing water, field operations that occur at the subsurface (e.g., in a fractured subterranean formation adjacent to a well) may be improved, which may lead to additional subterranean resources being extracted from the subsurface and/or increasing the injection capacity and life of a SWD well. Examples of such additional subterranean resources may include, but are not limited to, oil and natural gas. Example embodiments may be used as a pre-treatment of a fluid used for one or more subsurface field operations. Use of example embodiments on production and injection wells may be designed to comply with certain standards and/or requirements. Example embodiments may be used for wellbores drilled in conventional and/or unconventional (e.g., tight shale) subterranean formations and reservoirs.

As defined herein, enhancing water chemistry is changing the chemistry of water in some way in order to put the water in a condition that is usable for a particular purpose. The water chemistry can be enhanced in any of a number of ways. For example, one or more additives (discussed below) can be added to the water to change the chemistry of the water. The resulting water can then be used for some purpose. By changing the chemistry of the water, particular problems (e.g., scale deposition, corrosion) can be reduced or avoided when the water is used for the purpose (e.g., fracturing, hydrocarbon production).

As defined herein, improved well performance is improving a measurable parameter (e.g., output, production, flow rate) of a well. The improvement can apply to a particular field operation (e.g., fracturing (e.g., hydraulic fracturing), hydrocarbon production) performed on the well. In addition, or in the alternative, the improvement can apply to the overall well. In addition, or in the alternative, the improvement can apply to multiple wells (e.g., adjacent wells from a common wellpad).

In some cases, enhancing water chemistry for improved well performance may result, for example, in reducing pH, reducing calcium, and/or reducing deposition of scales and/or other solids, which may result in extracting a larger volume of subterranean resources from a subterranean formation for a longer period of time and/or extending the well life. As defined herein, reducing deposition of scales and/or other solids may involve any of a number of different actions. For example, reducing deposition of scales and/or other solids may include minimizing the accumulation or deposition of scales and/or other solids without completely eliminating the scales and/or other solids. As another example, reducing deposition of scales and/or other solids as defined herein may additionally or alternatively mean preventing the development of scale depositions and/or other solids. As yet another example, reducing deposition of scales and/or other solids as defined herein may additionally or alternatively mean completely eliminating scales and/or other solids that have previously developed. Enhancing water chemistry for improved well performance may be applied in various scenarios, including but not limited to SWD wells, processing facilities, and production wells.

Example embodiments of enhancing water chemistry for improved well performance (e.g., for injection SWD wells, for production wells) may be at a subsurface (e.g., within and adjacent to a wellbore in a subterranean formation) for injection (e.g., SWD) wells and production wells (e.g., wells undergoing a fracturing operation). Example embodiments of enhancing water chemistry for improved well performance may additionally or alternatively be used in any of a number of other applications. For instance, example embodiments may be used to reduce deposition of scales and/or other solids for improved performance in surface equipment. Such surface equipment may include, but is not limited to, heat exchangers and conduit or other pipes (e.g., a pipeline, a drainpipe) used to transport fluid (e.g., natural gas).

As defined herein, enhancing water chemistry is based on identifying an additive that mixes with water (e.g., water used for a fracturing stage of a field operation, injection water used in a SWD well), where the water includes one or more types of solid-generating components (e.g., multi-valent cations such as Ca²⁺, Ba²⁺, Sr²⁺, Mg²⁺, Fe²⁺, etc.). The additive may include one or more non-salt chemical compounds (e.g., CO₂) and/or one or more salts (e.g., NaOH, NaHCO₃, Na₂CO₃, etc.). Example embodiments identify the additive to be used, both in terms of the contents (e.g., salts, non-salt compounds) of the additive and in terms of the concentration of each of the contents of the additive. The additive used in example embodiments is designed to produce one or more of a number of results. Examples of such results may include, but are not limited to, manipulation of the content (chemistry) of the enhanced water for different purposes (e.g., subsurface fracturing, subsurface water disposal via injection), reducing or eliminating the amount of a scale-generating component in the enhanced water relative to the water before enhancement, enhancing the composition of lift gas by removing acidic compounds (resulting in reduced corrosion), reducing CO₂ in lift gas (potentially resulting in reduced corrosion), and generating a particular solid that results from the additive mixing with the water before enhancement.

As defined herein, water before enhancement may be of any type and/or from any source of water, including but not limited to produced water, without adding any chemicals or making any other alterations to the water. Alternatively, water before enhancement may be of any type and/or from any source of water that has added thereto one or more chemicals and/or has otherwise been altered in some way that does not include introducing the additive discussed herein to the water. The water before enhancement may include one or more types of solid-generating components (e.g., bivalent cations, trivalent cations). In addition, the water before enhancement may include various amounts of total dissolved solids (TDSs) (e.g., between 1,000 mg/L and 500,000 mg/L, between 30,000 mg/L and 100,000 mg/L, between 50,000 mg/L and 250,000 mg/L, between 20,000 mg/L and 50,000 mg/L, between 100,000 mg/L and 200,000 mg/L).

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subterranean formation” refers to practically any volume under a surface. For example, it may be practically any volume under a terrestrial surface (e.g., a land surface), practically any volume under a seafloor, etc. Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to: shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subterranean formation ” is not limited to any description or configuration described herein.

A “well” or a “wellbore” refers to a single hole, usually cylindrical, that is drilled into a subsurface volume of interest. A well or a wellbore may be drilled in one or more directions. For example, a well or a wellbore may include a vertical well, a horizontal well, a deviated well, and/or other type of well. A well or a wellbore may be drilled in the subterranean formation for exploration and/or recovery of resources. A plurality of wells (e.g., tens to hundreds of wells) or a plurality of wellbores are often used in a field depending on the desired outcome.

A well or a wellbore may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the subterranean formation, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but is not described, the description for such component may be substantially the same as the description for the corresponding component in another figure. The numbering scheme for the various components in the figures herein is such that each component is a three-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of enhancing water chemistry for improved well performance will be described more fully hereinafter with reference to the accompanying drawings, in which example embodiments of enhancing water chemistry for improved well performance are shown. Enhancing water chemistry for improved well performance may, however, be embodied in many different forms and should not be construed as limited to the example embodiments set forth herein. Rather, these example embodiments are provided so that this disclosure will be thorough and complete, and will fully convey the scope of enhancing water chemistry for improved well performance to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of enhancing water chemistry for improved well performance. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

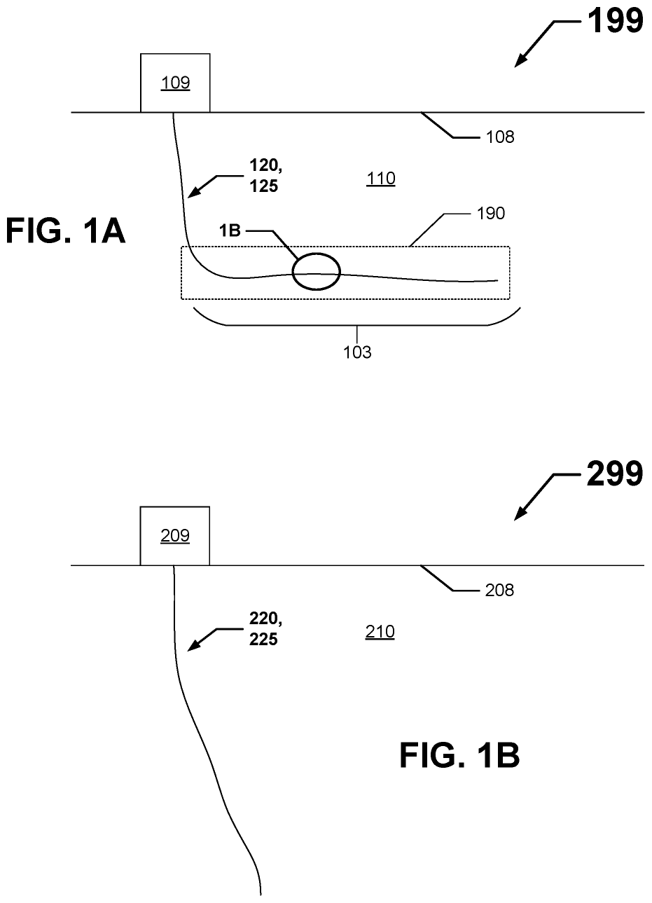

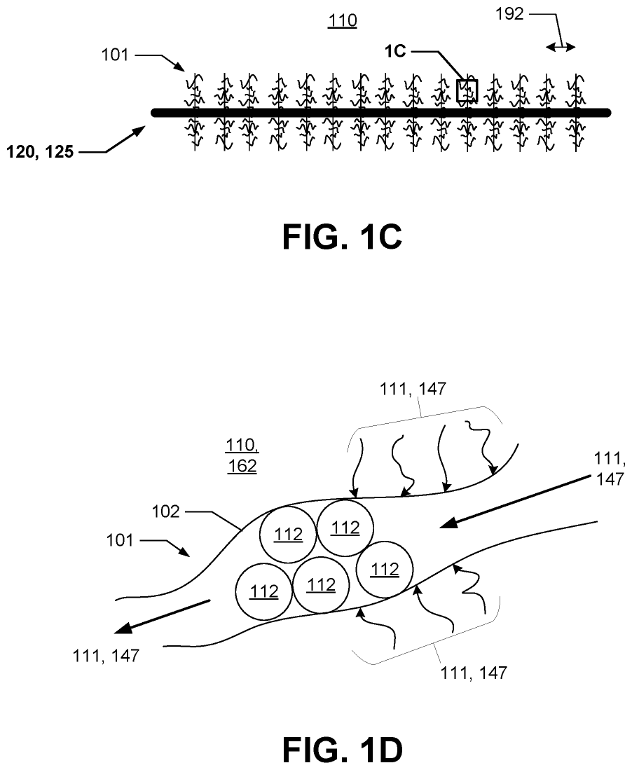

FIGS. 1A through 1D show a field system 199, including details thereof, with which example embodiments may be used. Specifically, FIG. 1A shows a schematic diagram of a land-based field system 199 in which a wellbore 120 has been drilled in a subterranean formation 110 and in which water chemically enhanced using example embodiments may be used. FIG. 1B shows a schematic diagram of another land-based field system 299 in which a wellbore 220 has been drilled in a subterranean formation 210 and in which water chemically enhanced using example embodiments may be used. FIG. 1C shows a detail of a substantially horizontal section 103 of the wellbore 120 of FIG. 1A. FIG. 1D shows a detail of a fracture 101 of FIG. 1B. The field system 199 of FIG. 1A includes a producing wellbore 120 disposed in a subterranean formation 110 using field equipment 109 (e.g., a derrick, a tool pusher, a clamp, a tong, drill pipe, casing pipe, a drill bit, a wireline tool, a fluid pumping system) located above a surface 108 and within the wellbore 120. Example embodiments may also be used in other types of wells (e.g., injection wells) that have vertical sections (as in FIGS. 1A and 1B) and/or horizontal sections (as in FIG. 1A).

With respect to the system 199 of FIG. 1A, once the wellbore 120 is drilled, a casing string 125 is inserted into the wellbore 120 to stabilize the wellbore 120 and allow for the extraction of subterranean resources (e.g., natural gas, oil, produced water) from the subterranean formation 110. Field equipment 109, located at the surface 108, is used to drill, encase, fracture, produce, and/or perform any other part of a field operation with respect to the wellbore 120. The wellbore 120 of FIG. 1A starts out as substantially vertical, and then has a substantially horizontal section 103. This configuration of the wellbore 120 is common for exploration and production of subterranean resources, such as oil and natural gas.

Similarly, with respect to the system 299 of FIG. 1B, once the wellbore 220 is drilled, a casing string 225 is inserted into the wellbore 220 to stabilize the wellbore 220 from the subterranean formation 210. Field equipment 209, located at the surface 208, is used to drill, encase, fracture, produce, and/or perform any other part of a field operation with respect to the wellbore 220. The wellbore 220 of FIG. 1B is substantially vertical. This configuration of the wellbore 220 is common for injection wells.

Referring back to FIG. 1A, the surface 108 may be ground level for an onshore application and the sea floor (or other similar floor under a body of water) for an offshore application. A body of water may include, but it not limited to, sea water, brackish water, flowback or produced water, wastewater (e.g., reclaimed or recycled), brine (e.g., reservoir or synthetic brine), fresh water (e.g., fresh water comprises <1,000 ppm TDS), any other type of water, or any combination thereof. For offshore applications, at least some of the field equipment may be located on a platform that sits above the water level. The point where the wellbore 120 begins at the surface 108 may be called the wellhead. While not shown in FIGS. 1A and 1B, there may be multiple wellbores 120, 220, each with its own wellhead but that is located close to the other wellheads, drilled into the subterranean formation 110, 210 and having substantially vertical sections and/or horizontal sections 103 that are close to each other. In such a case, the multiple wellbores 120, 220 may be drilled at the same pad or at different pads.

During the process of drilling the wellbore 120 of FIG. 1A, cuttings, produced water 147, and other subterranean resources 111 (e.g., relatively small amounts of oil or natural gas) are extracted from downhole to the surface 108, where some of the field equipment 109 separates out at least some of the cuttings and recirculates the produced water back downhole. When the drilling process is complete, other operations, such as fracturing operations, may be performed. While the subterranean formation 110 may have naturally-occurring fractures and some fractures that may be created when drilling the wellbore 120, these fractures may need to be enlarged and elongated, and additional fractures need to be created, in order to extract additional subterranean resources 111 (e.g., oil, natural gas) from the subsurface. The fractures 101 are shown to be located in the horizontal section 103 of the wellbore 120 in FIG. 1B. The fractures 101, whether created and/or naturally occurring, may additionally or alternatively be located in other sections (e.g., a substantially vertical section, a transition area between a vertical section and a horizontal section) of the wellbore 120. In some cases, a wellbore 120 has no substantially horizontal sections. Example embodiments may be used along any portion of the wellbore 120 where fractures 101 are located.

The subterranean formation 110 may include one or more of a number of formation types, including but not limited to shale, limestone, sandstone, clay, sand, and salt. In certain embodiments, a subterranean formation 110 may include one or more reservoirs in which one or more resources (e.g., oil, natural gas, water, steam) may be located. One or more of a number of field operations (e.g., fracturing, coring, tripping, drilling, setting casing, extracting downhole resources) may be performed to reach an objective of a user with respect to the subterranean formation 110.

The wellbore 120 may have one or more of a number of segments or hole sections, where each segment or hole section may have one or more of a number of dimensions. Examples of such dimensions may include, but are not limited to, a size (e.g., diameter) of the wellbore 120, a curvature of the wellbore 120, a total vertical depth of the wellbore 120, a measured depth of the wellbore 120, and a horizontal displacement of the wellbore 120. There may be multiple overlapping casing strings of various sizes (e.g., length, outer diameter) contained within and between these segments or hole sections to ensure the integrity of the wellbore construction. In this case, one or more of the segments of the subterranean wellbore 120 is the substantially horizontal section 103.

As discussed above, inserted into and disposed within the wellbore 120 of FIGS. 1A and 1B are a number of casing pipes that are coupled to each other end-to-end to form the casing string 125. In this case, each end of a casing pipe has mating threads (a type of coupling feature) disposed thereon, allowing a casing pipe to be directly or indirectly mechanically coupled to another casing pipe in an end-to-end configuration. The casing pipes of the casing string 125 may be indirectly mechanically coupled to each other using a coupling device, such as a coupling sleeve.

Each casing pipe of the casing string 125 may have a length and a width (e.g., outer diameter). The length of a casing pipe may vary. For example, a common length of a casing pipe is approximately 40 feet. The length of a casing pipe may be longer (e.g., 60 feet) or shorter (e.g., 10 feet) than 40 feet. The width of a casing pipe may also vary and may depend on the cross-sectional shape of the casing pipe. For example, when the shape of the casing pipe is cylindrical, the width may refer to an outer diameter, an inner diameter, or some other form of measurement of the casing pipe. Examples of a width in terms of an outer diameter may include, but are not limited to, 4½ inches, 7 inches, 7⅝ inches, 8⅝ inches, 10¾ inches, 13⅜ inches, and 14 inches.

The size (e.g., width, length) of the casing string 125 may be based on the information (e.g., diameter of the borehole drilled) gathered using field equipment with respect to the subterranean wellbore 120. The walls of the casing string 125 have an inner surface that forms a cavity that traverses the length of the casing string 125. Each casing pipe may be made of one or more of a number of suitable materials, including but not limited to steel. Cement is poured into the wellbore 120 through the cavity and then forced upward between the outer surface of the casing string 125 and the wall of the subterranean wellbore 120. In some cases, a liner may additionally be used with, or alternatively be used in place of, some or all of the casing pipes.

Once the cement dries to form concrete, a number of fractures 101 are created in the subterranean formation 110. The fractures 101 may be created in any of a number of ways known in the industry, including but not limited to hydraulic fracturing, fracturing using electrodes, and/or other methods of inducing fractures. The hydraulic fracturing process involves the injection of large quantities of fluids containing water, chemical additives, and proppant 112 into the subterranean formation 110 from the wellbore 120 to create fracture networks. An example of fracturing using electrodes may be found in U.S. Pat. No. 9,840,898 issued on Dec. 12, 2017, to Kasevich et al., the entirety of which is herein incorporated by reference. A subterranean formation 110 naturally has fractures 101, but these naturally occurring fractures 101 have inconsistent characteristics (e.g., length, spacing) and so in some cases cannot be relied upon for extracting subterranean resources without having additional fractures 101, such as what is shown in FIG. 1B, created in the subterranean formation 110.

Operations that create fractures 101 in the subterranean formation 110 use any of a number of fluids that include proppant 112 (e.g., sand, ceramic pellets). When proppant 112 is used, some of the fractures 101 (also sometimes called principal or primary fractures) receive proppant 112, while a remainder of the fractures 101 (also sometimes called secondary fractures) do not have any proppant 112 in them.

As shown in FIG. 1C, the proppant 112 is designed to become lodged inside at least some of the created fractures 101 to keep those fractures 101 open after the fracturing operation is complete. The size of the proppant 112 is an important design consideration. Sizes (e.g., 40/70 mesh, 50/140 mesh) of the proppant 112 may vary. While the shape of the proppant 112 is shown as being uniformly spherical, and the size is substantially identical among the proppant 112, the actual sizes and shapes of the proppant 112 may vary. If the proppant 112 is too small, the proppant 112 will not be effective at keeping the fractures 101 open enough to effectively allow produced water 147 and/or other subterranean resources 111 to flow through the fractures 101 from the rock matrices 162 in the subterranean formation 110 to the wellbore 120. If the proppant 112 is too large, the proppant 112 may plug up the fractures 101, blocking the flow of the produced water 147 and/or other subterranean resources 111 through the fractures 101.

The use of proppant 112 in certain types of subterranean formation 110, such as shale, is important. Shale formations typically have permeabilities on the order of microdarcys (μD) to nanodarcys (nD). When fractures 101 are created in such formations with low permeabilities, it is important to sustain the fractures 101 and their permeability and conductivity for an extended period of time in order to extract more of the subterranean resource 111. Example embodiments can also be applied to fluids used in other types of field operations, including but not limited to fracturing operations and injection wells.

The various created fractures 101 that originate at the wellbore 120 and extend outward into the rock matrices 162 in the subterranean formation 110 in this case have consistent penetration lengths perpendicular to the wellbore 120 and have consistent coverage along at least a portion of the lateral length (substantially horizontal section) of the wellbore 120. For example, created fractures 101 may be 50 meters high and 200 meters long. Further, the created fractures 101 may be spaced a distance 192 apart from each other. The distance 192 (e.g., 25 meters, 5 meters, 12 meters) may be optimized based on the permeability and the porosity of the rock matrix 162 of the subterranean formation 110.

The created fractures 101 create a volume 190 within the subterranean formation 110 where the rock matrix 162 of the subterranean formation 110 is connected to the high conductivity fractures 101 located a short distance away. In addition to different configurations of the fractures 101, other factors that may contribute to the viability of the subterranean formation 110 may include, but are not limited to, permeability of the rock matrix 162, capillary pressure, and the temperature and pressure of the subterranean formation 110. Each fracture 101, whether created or naturally occurring, is defined by a wall 102, also called a frac face 102 herein. The frac face 102 provides a transition between the paths formed by the rock matrices 162 in the subterranean formation 110 and the fracture 101. The subterranean resources 111 flow through the paths formed by the rock matrices 162 in the subterranean formation 110 into the fracture 101.

The rock matrices 162, as well as the rest of the subterranean formation 110, both without and outside the volume 190, have a certain amount of formation water 147 therein. The produced water 147 may be or include, for example, formation water from the formation matrix within the volume 190, moveable free formation water, and “external” water from non-targeted formation/sources (e.g., outside the target volume 190). These sources of produced water 147 may include water from nearby SWD wells or other sources.

The produced water 147 may have any of a number of different components (e.g., minerals, chemical additives, acids, completion brine) in addition to formation water. The contents of produced water 147 in one part (e.g., outside the volume 190) of the subterranean formation 110 may be the same as, or different than, the contents of the produced water 147 in other parts (e.g., in the rock matrices 162) of the subterranean formation 110. In some cases, such as during a stage (e.g., a hydraulic fracturing stage) of a field operation, the fluids (e.g., fracturing fluid) used in that stage may mix with or include the produced water 147, thereby changing the contents or composition of the in situ water chemistry in parts (e.g., at or near the fractures 101) of the subterranean formation 110. The produced water 147 may include one or more of a number of types of water, including but not limited to sea water, brackish water, flowback or produced water, wastewater (e.g., reclaimed or recycled), brine (e.g., reservoir or synthetic brine), fresh water (e.g., fresh water comprises <1,000 ppm TDS), any other type of water, or any combination thereof.

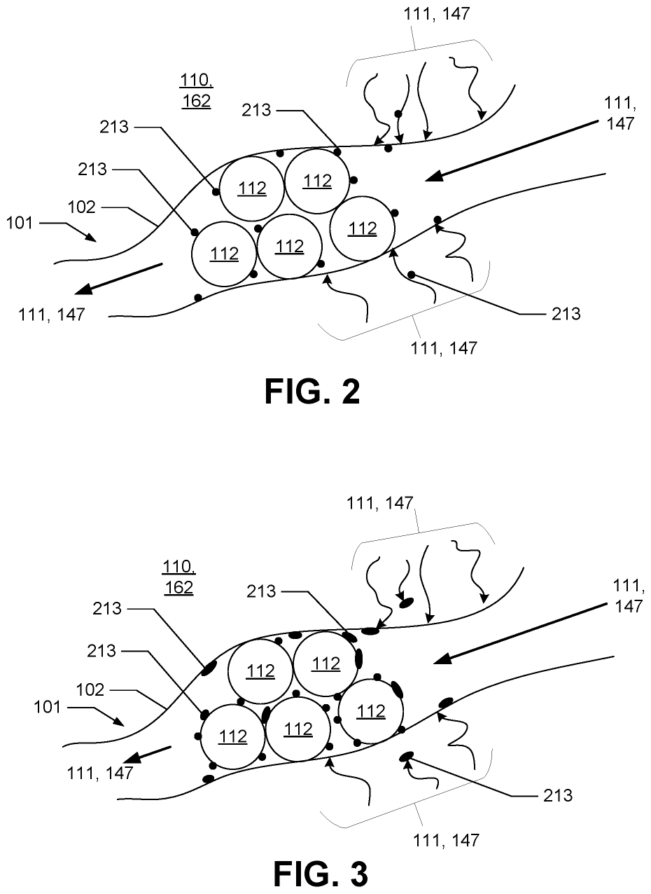

FIG. 2 shows the detail of FIG. 1C at a subsequent point in time relative to the time captured in FIG. 1C. FIG. 3 shows the detail of FIG. 2 at a subsequent point in time relative to the time captured in FIG. 2. For example, FIG. 2 may show the detail of FIG. 1C six months later (e.g., at the initial stage when the well is put on production) than the time captured in FIG. 1C after flowing a fluid (e.g., a fluid that includes the produced water 147) therethrough, and FIG. 3 may show the detail of FIG. 2 three months later than the time captured in FIG. 2 after continuing to flow the fluid therethrough. Referring to FIGS. 1A through 3, the detail in FIG. 2 shows, in addition to the proppant 112 within the fracture 101, produced water 147 and/or another subterranean resource 111 (e.g., natural gas, oil) is shown flowing within the fracture 101 from the rock matrix 162, around the proppant 112 in the fracture 101, and on to the wellbore 120. In some cases, the subterranean resource 111 is co-present or mixed with the produced water 147.

As the produced water 147 and the other subterranean resource(s) 111 flows within the paths formed by the rock matrices 162 and around the proppant 112 in the fracture 101, scale depositions 213 may occur (e.g., scale particles formed during the shut-in stage before the well is put on production) within the rock matrices 162, on the proppant 112, and/or on the frac face 102. Specifically, components of the produced water 147, such as one or more types of multi-valent cations and/or other types of solid-generating components, may form the basis of the scale depositions 213 and/or other solid accumulations. Over time, the scale depositions 213 may begin to accumulate on the rock matrices 162, on the proppant 112, and/or on the frac face 102. Each of the scale depositions 213 is an inorganic deposit from ionic materials in water (e.g., the produced water 147) that attaches to solid surfaces. Hydrocarbons may be adsorbed on scale depositions 213. Under field conditions, scale depositions 213 may be a mixture of inorganic and organic components.

Scale depositions 213 may be initiated during a prior phase (e.g., completion) of a field operation, where fluids and chemicals used downhole may interact with formation rock (e.g., the frac face 102, the rock matrices 162) and comingle with the produced water 147 in and/or near perforations and along the fractures 101, resulting in the mobilization and release of elements from the rock matrices 162 adjacent to the fractures 101. Later, in a subsequent phase (e.g., shutting in) of the field operation, the rock-fluid interaction and the commingling of different fluids may lead to the formation (crystallization) and growth of scale depositions 213 in or near the perforations, the rock matrices 162, and the fractures 101. In yet another subsequent phase (e.g., production) of the field operation, the degradation in the conductivity and production flow path over time in the rock matrices 162 and the fractures 101, caused by agglomerate build-up of scale depositions 213, may lead to plugging in or near the perforations, rock matrices 162, fractures 101, equipment at the surface, and/or production wells.

The scale depositions 213 that accumulate within the rock matrices 162 and the fractures 101 may be composed of one or more of any of a number of compounds, including but not limited to calcium carbonate (CaCO₃), barium sulfate (BaSO₄), calcium sulfate (CaSO₄), strontium sulfate (Sr₅O₄), iron carbonate (FeCO₃), iron oxide (Fe₂O₃), iron sulfide (FeS), zinc sulfide (ZnS), other oxides, other sulfides, other carbonates, other sulfates, halides, and hydroxides. At least some of these compounds involve multi-valent cations found in the produced water 147. While the scale depositions 213 may additionally or alternatively be composed of other compounds (e.g., gas hydrates, organic deposits (e.g., asphaltenes, waxes, acid induced or otherwise created accumulations), and naphthenates), example embodiments focus on the reduction of scale depositions 213 caused by inorganic deposits. The scale depositions 213 may be caused by one or more of any of a number of factors, including but not limited to supersaturation, mixing incompatible ions, changes in temperature, changes in pressure, and a change in the pH of water in the fluid.

Scale depositions 213 may form during the shut-in stage prior to the well being put into production, as shown in FIG. 2. In such a case, the scale depositions 213 disposed on the rock matrices 162, on the proppant 112, and on the frac face 102 are small and spotty. As a result, the scale depositions 213 may not significantly impact the flow of the subterranean resource 111 through the paths within the rock matrices 162 and around the proppant 112 within the fracture 101 formed by the frac face 102. In the portion of the fracture 101 shown at the time captured in FIG. 2, there are 2 separate scale depositions 213 within the rock matrices 162, 8 scale depositions 213 on the proppant 112, and 4 scale depositions 213 on the frac face 102. The number, size, and location of the scale depositions 213 within the rock matrices 162 and the fracture 101 may vary.

When the well is put on production, some scale depositions 213 may stay at their original position, while some scale particles may move/migrate together with the produced water 147 and deposit at another location along the production pathway. As more produced water 147 is produced, the existing scale depositions 213 may increase in size and new scale depositions 213 may develop over time. An example of this is captured in FIG. 3, which shows that the scale depositions 213 become larger and less spotty. As a result, the scale depositions 213 in FIG. 3 begin to contribute to inhibit the flow of the produced water 147 and/or other subterranean resources 111 (e.g., hydrocarbons) along the paths formed by the rock matrices 162, through the frac face 102 (impacting migration of the produced water 147 and/or other subterranean resources 111 from the rock matrix 162), and around the proppant 112 (combined with the scale depositions 213 on the proppant 112 and on the frac face 102) within the fracture 101.

As a result, scale depositions 213 may cause a decrease (in some cases, a significant decrease) in well productivity and estimated ultimate recovery (EUR) for the well. Similarly, if the well is used for SWD, the scale depositions 213 (e.g., from injection water, with flow via wellhead to wellbore and formation) may clog or restrict the flow paths into the subterranean formation 110, thereby limiting the useful capacity of the SWD well. In the portion of the fracture 101 shown at the time captured in FIG. 3, there are 25 separate scale depositions 213 within the rock matrices 162, at the frac face 102, and on the proppant 112, many of which are larger (in some cases, significantly larger) than the size of the scale depositions 213 shown in FIG. 2. Also, some of the scale depositions 213 in FIG. 3 have migrated to a new location relative to their location in FIG. 2. Again, the number, size, and location of the scale depositions 213 within the fracture 101 may vary.

In field operations, scale inhibitor and/or other chemical agents (e.g., biocide) may be included in frac fluid to inhibit/control mineral scale depositions (a form of scale depositions 213) during hydraulic fracturing operations. As frac fluid is injected into the subsurface, it may interact with the frac face 102, proppant, rock matrices, produced water 147, and other elements in the volume 190. Rock-water interaction and fluid commingling may potentially lead to increased risk of scale depositions 213 and solid formation (e.g., create other types of blockage in the fractures 101), leading to adverse effects (e.g., create other types of blockage in the fractures 101) on production performance. In some cases, excessive amounts or inappropriate application of scale inhibitor and/or other chemical additives may lead to increased risk in the development of scale depositions 213, corrosion, incompatibility, and other production issues.

There has been uncertainty whether the scale inhibitor included in frac

fluid (also sometimes called fracturing fluid, frac water, or fracturing water herein) may reduce/prevent scale depositions 213 at the subsurface during the shut-in stage of a field operation prior to the production stage of the field operation. It is important to optimize scale management, which in example embodiments includes, for example, selecting the one or more optimal or recommended additives among a number of different additives for a given composition of produced water 147, determining the appropriate concentration of the optimal or recommended additive for a given composition of produced water 147), in order to increase/optimize recovery of other subterranean resources 111 from the subterranean formation 110 or to increase/optimize storage capability of a SWD well within the subterranean formation 110.

In addition, or in the alternative, example embodiments may be used to generate one or more particular solids when the water (e.g., produced water 147) before enhancement is mixed with one or more additives (e.g., CO₂, gas containing CO₂ purged through the water, alkali salts), which may be added into the system via different approaches. These solids may include some or all of the multi-valent cations (and/or other solid-generating components) found in the (or other type of water) produced water 147 before enhancement. These solids may be used as a byproduct in the same field operation that generates the produced water 147 (or other type of water) without enhancement or in an unrelated field operation (e.g., cementing, pavement, specialty industries construction material (in the form of limestone and marble), pigment, agricultural soil treatment, pharmaceutical, acid neutralizer in the chemical industry). Since these induced or otherwise created solids may also have concentrated forms of valuable trace elements (e.g., Li+, rare earth elements, NORM, etc.) from the produced water 147 (or other type of water), such byproducts may also be of value in other industries either in bulk or following purification and/or other types of processing.

Example embodiments are designed to optimize the reaction between produced water 147 (or other type of water) and additives by taking visual observations and/or analyzing the post-reaction composition when the produced water 147 (or other type of water) and the additives are mixed. These tests may be conducted at any pressure, at any temperature, and for any length of time. The one or more additives used in example embodiments are designed to capture the multi-valent cations (e.g., Ca²⁺), other solid-generating components, and/or other components of interest (e.g., lithium) of the produced water 147 (or other type of water) into a solid that may be physically removed.

As discussed above, such solids may be used in the same or another unrelated field operation based on the characterization and classification methods of the included solids. Further, the enhanced water chemistry may be used in the present field operation (e.g., for fracturing, for SWD) with reduced, little, or no risk of scale depositions 213 developing. In this way, the enhanced water chemistry may enhance production of the subterranean resource 111 within the volume 190. When water with enhanced chemistry using example embodiments is used for injection into SWD wells, the injectivity and performance of the SWD well may be improved due to the lower/no scaling risk and potential permeability increase due to interaction between rock and the enhanced water with divalent/multi-valent cations.

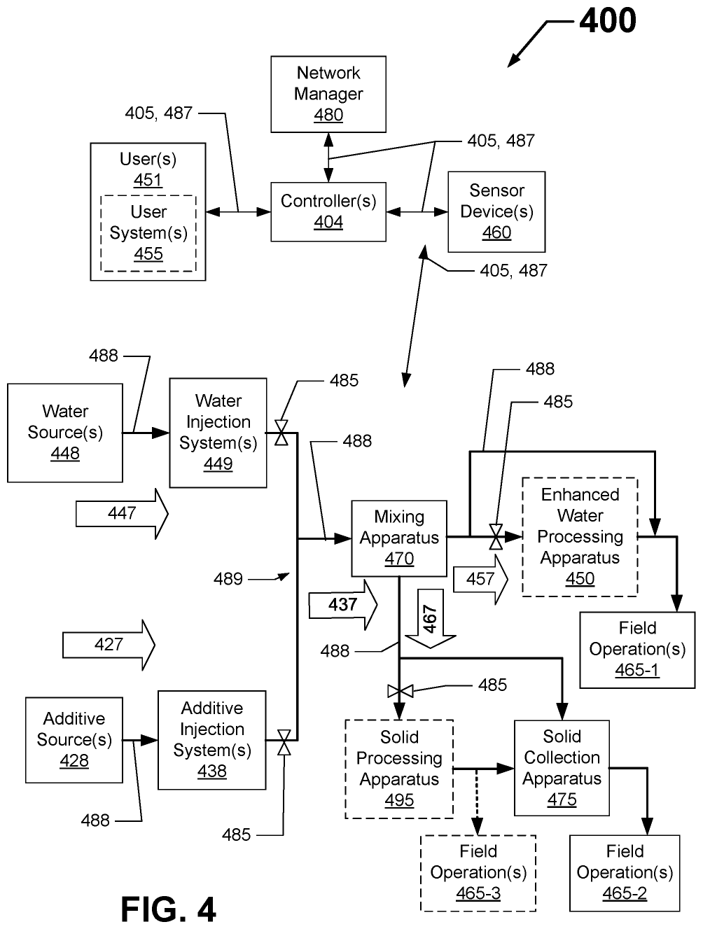

FIG. 4 shows a diagram of a system 400 for enhancing water chemistry for improved well performance according to certain example embodiments. The system 400 of FIG. 4 includes one or more additive sources 428, one or more water sources 448, one or more additive injection systems 438, one or more water injection systems 449, a mixing apparatus 470, an optional enhanced water processing apparatus 450, an optional solid processing apparatus 495, a solid collection apparatus 475, one or more controllers 404, one or more sensor devices 460, one or more users 451 (including one or more optional user systems 455), a network manager 480, piping 488, and one or more valves 485.

The components shown in FIG. 4 are not exhaustive, and in some embodiments, one or more of the components shown in FIG. 4 may not be included in the example system 400. Any component of the system 400 may be discrete or combined with one or more other components of the system 400. Also, one or more components of the system 400 may have different configurations. For example, one or more sensor devices 460 may be disposed within or disposed on other components (e.g., the piping 488, a valve 485, the mixing apparatus 470, the solid collection apparatus 475). As another example, a controller 404, rather than being a stand-alone device, may be part of one or more other components (e.g., the mixing apparatus 470, the solid collection apparatus 475, an additive injection system 438) of the system 400.

Referring to FIGS. 1A through 4, the system 400 may be used as a testing environment (e.g., to test the results of mixing different sources of water 447 at varying concentrations with different additives 427 at varying concentrations) and/or as part of a field trial or field application. As a result, the system 400 may be used to enhance the chemistry of water 447 using certain additives 427 in certain concentrations to optimize the results (e.g., minimize or eliminate scale depositions 213) of a particular field operation 465 (e.g., a fracturing procedure).

The system 400 may include one or more water sources 448. Each water source 448 may hold water 447. The water 447 may be any type of water, including but not limited to the produced water (e.g., produced water 147 discussed above with respect to FIGS. 1A through 3), sea water, brackish water, wastewater (e.g., reclaimed or recycled), brine (e.g., reservoir or synthetic brine), fresh water (e.g., fresh water comprises <1,000 ppm TDS), or any other type of water. One example of a water source 448 may be a wellbore (e.g., wellbore 120). Another example of a water source 448 may be a processing system (e.g., part of the field equipment 109) that is designed to separate cuttings, other subterranean resources 111 (e.g., oil, natural gas), and/or other elements from the water 447 as the water 447 is prepared for recirculation into the wellbore or another wellbore (e.g., a SWD well). A water source 448 may be or include, by way of non-limiting examples, a natural vessel (e.g., land that forms a body of water) and a man-made storage tank or vessel. As an example, when the water 447 is produced water, the water 447 may contain some amount (e.g., 1000 mg/L to 12000 mg/L) of one or more multivalent cations (e.g., Ca²⁺), have a high amount (e.g., over 20,000-30,000 mg/L of Ca²⁺) of water hardness, and/or have a high amount (e.g., 5 mg/L, 10 mg/L, 250 mg/L, 500 mg/L, 900 mg/L) of total suspended solids.

The water 447 is moved from each water source 448 toward the mixing apparatus 470 using one or more water injection systems 449. Each water injection system 449 is configured to extract water 447 from a water source 448 and push the water 447 toward the mixing apparatus 470. The number of water injection systems 449 in the system 400 may vary. In some embodiments, there may be one water injection system 449 for each water source 448. In alternative embodiments, there may be one water injection system 449 for multiple water sources 448. Each water injection system 449 may include one or more of a number of pieces of equipment to perform its function. Examples of such equipment may include, but are not limited to, a compressor, a motor, a pump, piping (part of the conveyance system 488, discussed below), a valve (e.g., valve 485), a controller (e.g., controller 404), and a sensor device (e.g., sensor device 460). Some or all of the water injection system 449 may operate using a controller 404. In addition, or in the alternative, one or more users 451 may perform one or more of the various functions required to move some or all of the water 447 using the water injection system 449.

The system 400 may also include one or more additive sources 428. Each additive source 428 may hold one or more additives 427. An additive source 428 may include, but is not limited to, a natural vessel (e.g., land that forms walls to contain a liquid, a subterranean cavity that holds carbon dioxide or other gas or liquid) and a man-made storage tank or other type of vessel. Each additive 427 may be or include a liquid, a solid, and/or a gas. An additive 427 may be in the form of a liquid, a gas, and/or a solid. A single additive 427 or a mixture of multiple additives 427 may be disposed in an additive source 428.

Examples of an additive 427 may include, but are not limited to, carbon dioxide, gas with various concentrations of CO₂ (e.g., in liquid form, in gas form, in produced gas from a field operation, from a source external to a field operation), hydrocarbons, CO₂ from combusted hydrocarbons (e.g., CO₂ from an electrical generating process, either with or without processing, a gas compressor), methane, H₂S, nucleation catalyzing metals, an alkali salt (e.g., NaOH), sodium bicarbonate (NaHCO₃), sodium carbonate (Na₂CO₃), polymers and/or other substances that may accelerate or improve the separation of solids 467, and flocculation agents that may accelerate the deposition of solids. In one embodiment, exhaust gas from one or more turbines may be used as-is without further processing, such as gas turbine exhaust streams having some range (e.g., 2%-10%, 1%-20%) CO₂ concentration. When an additive 427 is an alkali salt (e.g., NaOH), the alkali salt (in any type of form) may be purchased and/or generated onsite using different approaches such as electrochemistry methods. An additive 427 may be configured (e.g., be of a type, have a concentration/amount) to react with a solid-generating component (e.g., a multi-valent cation) of the water 447 and generate a solid 467. When an additive 427 includes CO₂, the additive 427 may have, for example, a CO₂ concentration of between 0.1% and 100%, a CO₂ concentration of between 0.1% and 20%, a CO₂ concentration of between 1.0% and 10.0%.

An additive 427 may serve one or more purposes in one or more field operations 465. For example, an additive 427 may be used to remove one or more solid-generating components of the water 447 by reacting with the one or more solid-generating components to generate one or more solids 467, discussed below. The resulting enhanced water 457, when used in one or more subsequent field operations 465-1 (e.g., fracturing), or part thereof, may improve or maximize utilization of the well for the field operation 465-1 in which the enhanced water 457 is used because of the lack of solid-generating components. As another example, an additive 427 may be used to generate a certain type of solid 467 (e.g., calcium carbonate), which may be used for some separate process or field operation 465-2 (e.g., cement for construction, building materials, construction material, concrete, acid neutralization, soil treatment, color enhancement, flooring material). As yet another example, an additive 427 is carbon dioxide, a gas stream containing sequestered/stored carbon dioxide, or any combination thereof. One of ordinary skill in the art will appreciate that other additives 427 and/or combinations thereof are possible in example embodiments.

In cases when an additive 427 is CO₂, another additive 427 may be an alkaline solution (e.g., NaOH), which may be added in amounts up to the solubility limit of NaOH in saline solutions. Ratios on additive solution/solid addition to water 447 may depend on one or more of a number of factors, such as the composition of the water 447 and CO₂ levels in produced gas (as an additive 427). Conditions may determine the amounts of additive 427 needed to modify pH values and generate sufficient carbonate/bicarbonate intermediates to mix with water 447 for induced or otherwise created CaCO₃ and precipitation of other solids 467.

In some cases, the concentration range may be between 0.5 pounds and 10.0 pounds of NaOH (used as an additive 427) used per gallon of water 447 in high calcium concentration scenarios (e.g., between 1,000 mg/L and 30,000 mg/L, between 5,000 mg/L and 10,000 mg/L, between 15,000 mg/L and 20,000 mg/L). In other cases, the concentration range may be between 1.0 pounds and 5.0 pounds of NaOH (used as an additive 427) used per gallon of water 447 in high calcium concentration scenarios. In yet other cases, the concentration range may be between 3.0 pounds and 10.0 pounds of NaOH (used as an additive 427) used per gallon of water 447 in high calcium concentration scenarios. In some cases, carbonates and/or bicarbonates (instead of NaOH) may be obtained and used as an additive 427 from an external source if a source of CO₂ is not present in sufficient quantities in produced gas/available gas streams from a wellbore.

Each additive 427 is moved from each additive source 428 toward the mixing apparatus 470 using one or more additive injection systems 438. Each additive injection system 438 is configured to extract an additive 427 from an additive source 428 and push the additive 427 toward the mixing apparatus 470. The number of additive injection systems 438 in the system 400 may vary. In some embodiments, there may be one additive injection system 438 for each additive source 428. In alternative embodiments, there may be one additive injection system 438 for multiple additive sources 428. Each additive injection system 438 may include one or more of a number of pieces of equipment to perform its function. Examples of such equipment may include, but are not limited to, a compressor, a motor, a pump, piping (part of the conveyance system 488), a conveyer belt (another part of the conveyance system 488), a valve (e.g., valve 485), a controller (e.g., controller 404), and a sensor device (e.g., sensor device 460). Some or all of the additive injection system 438 may operate using a controller 404. In addition, or in the alternative, one or more users 451 may perform some or all of the various functions required to move some or all of the additives 427 using the additive injection system 438.

Whether inside the mixing apparatus 470 or in a collection area 489 (e.g., a header, a manifold) that is upstream of the mixing apparatus 470, the water 447 and the additives 427 are introduced to each other. If the water 447 and the additives 427 are introduced to each other upstream of the mixing apparatus 470, as shown in FIG. 4, then the combined product 437 is formed in the collection area 489. In either case, the mixing apparatus 470 mixes the combined product 437 to generate the enhanced water 457 and the one or more solids 467. In certain example embodiments, the mixing apparatus 470 may be configured to provide access to (e.g., expel via a port in the mixing apparatus 470, place into/onto part of the conveyance system 488 that leaves the mixing apparatus 470) the enhanced water 457 and/or the solids 467. The solids 467 are removable from the enhanced water 457.

Conditions (e.g., temperature, pressure) in some or all of the mixing apparatus 470 may vary and may be customized to represent field operating conditions, with temperature and pressure ranging from ambient conditions up to elevated conditions (e.g., 50° F.-150° F. for temperature, 50° F.-100° F. for temperature, 100° F.-150° F. for temperature, 30 psia-200 psia for pressure, 30 psia-110 psia for pressure, 60 psia-120 psia for pressure, 95 psia-200 psia for pressure). When an additive 427 is produced gas, the produced gas stream may be bubbled into an aqueous phase and subsequently converted to carbonate minerals. The influence of temperature on the precipitation of calcite (as a solid 467) is well understood by those of ordinary skill in the art.

To control the composition of the combined product 437 at a given point in time, the amount of the water 447 and the one or more additives 427 that are released or withdrawn from the water source(s) 448 and the additive source(s) 428, respectively, may be regulated in real time. This regulation may be performed automatically by a controller 404 and/or manually by a user 451 (which may include an associated user system 455). This regulation may be performed using equipment such as the one or more additive injection systems 438, the one or more water injection systems 449, valves 485, regulators, sensor devices 460, etc. The water 447 of a water source 448 and an additive 427 of an additive source 428 may have any of a number of different compositions that are naturally occurring or man-made.

The conveyance system 488 (including the collection area 489) may include any components, devices, subsystems, etc. that transport the water 447, the additives 427, the combined product 437, the enhanced water 457 (discussed below), and the one or more solids 467 (discussed below) within the system 400 from one component to another component. The conveyance system 488 may be configured to transport solids, liquids, and/or gases.

For example, in order to transport liquids and gases within the system 400, the conveyance system 488 may include piping. In such a case, the piping may include multiple pipes, ducts, elbows, joints, sleeves, collars, and similar components that are coupled to each other (e.g., using coupling features such as mating threads) to establish a network for transporting such liquids and/or gases within the system 400. Each component of the piping may have an appropriate size (e.g., inner diameter, outer diameter) and be made of an appropriate material (e.g., steel, PVC) to safely and efficiently handle the pressure, temperature, flow rate, and other characteristics of the liquids and/or gases that flow therethrough. As another example, in order to transport solids (e.g., solids 467) within the system 400, the conveyance system 488 may include conveyer belts, trucks, bulldozers, backhoes, and/or other similar equipment.

There may be a number of valves 485 placed in-line with the conveyance system 488 (or portions thereof) at various locations in the system 400 to control the flow of the water 447, the additives 427, the combined product 437, the enhanced water 457, and the one or more solids 467. A valve 485 may have one or more of any of a number of configurations, including but not limited to a guillotine valve, a ball valve, a gate valve, a butterfly valve, a pinch valve, a needle valve, a plug valve, a diaphragm valve, and a globe valve. One valve 485 may be configured the same as or differently compared to another valve 485 in the system 400. Also, one valve 485 may be controlled (e.g., manually by a user 451, automatically by the controller 404) the same as or differently compared to another valve 485 in the system 400.

The mixing apparatus 470 of the system 400 is configured to mix the water 447 and the additives 427 together. The mixing apparatus 470 may take one or more of any of a number of forms, including but not limited to a column, a test tube, a centrifuge mixer, a desander, a tumbler mixer, a homogenizer, a static mixer, a drum mixer, a fluidization mixer, agitator mixers, paddle mixers, an emulsifier, a drum mixer, a pail mixer, a convective mixer, an agitator, a batch mixer, and a ribbon mixer. The mixing apparatus 470 may include one or more of a number of features used to mix water 447 and the additives 427 together. The mixing apparatus 470 may operate substantially continuously (as when the water 447 and/or the additives 427 substantially continuously flow into the mixing apparatus 470) or at intervals (as when the water 447 and/or the additives 427 are introduced into the mixing apparatus 470 intermittently).

The mixing apparatus 470 may be or include a single apparatus (with or without multiple portions) or multiple apparatus (or portions thereof) that operate in series and/or in parallel with each other. As an example, the mixing apparatus 470 may include a temperature conditioning portion, a mixing portion, a drying portion, and a separating portion that operate in series with each other. As another example, the mixing apparatus 470 may include multiple mixers that operate in parallel with each other, where each mixer may mix a different combined product 437 simultaneously. In certain example embodiments, the combined product 437 requires more than merely a separator in the mixing apparatus 470 because the volume and/or mass of the solids 467 may be high. As a result, the mixing apparatus 470 may include equipment that allows for a piloted separation process that may depend on factors such as the chemistry of the water 447, the composition of the solids 467, and the rate of production.

The mixing apparatus 470 may control various aspects (e.g., temperature, pressure, flow rate) of the water 447, the additives 427, the combined product 437, the enhanced water 457, and/or the one or more solids 467. In some cases, the mixing apparatus 470 is designed to subject the water 447, the additives 427, the combined product 437, the enhanced water 457, and/or the one or more solids 467 to conditions (e.g., pressure, temperature, flow rate) that simulate the conditions at the subsurface (e.g., corresponding downhole conditions of the fractures 101 and rock matrix in the subterranean formation 110 adjacent to the wellbore 120).

The mixing apparatus 470 may include one or more of a number of pieces of equipment to perform these functions. Examples of such pieces of equipment may include, but are not limited to, a vessel, a funnel, a strainer, a separator, an agitator, a paddle, a circulating system, an aerator, a vibrating mechanism, a centrifuge, a motor, a pump, a compressor, piping, a valve (e.g., valve 485), a controller (e.g., controller 404), and a sensor device (e.g., sensor device 460). The various parts of the mixing apparatus 470 are configured (e.g., made of the proper material) to withstand the conditions (e.g., pressure, temperature, acidity, alkalinity) simulated by the mixing apparatus 470. Some or all of the mixing apparatus 470 may operate using a controller 404. In addition, or in the alternative, one or more users 451 (e.g., a human being) may control some or all of the various functions performed by the mixing apparatus 470.

In some cases, some or all of the mixing apparatus 470 may be paused or stopped so that the water 447, the additives 427, the combined product 437, the enhanced water 457, and/or the one or more solids 467 may be evaluated. For example, the enhanced water 457 may be tested to determine the type and/or amount of solid-generating components (e.g., multi-valent cations) and/or total dissolved solids (TDSs) therein. The enhanced water 457 may additionally or alternatively be tested (e.g., for cation concentrations, for pH) after leaving the mixing apparatus 470. Similarly, as another example, one or more characteristics (e.g., chemistry composition) of one or more of the solids 467 may be tested within the mixing apparatus 470 or downstream of the mixing apparatus 470. Testing herein may be conducted by a user 450 (e.g., a human being) and/or a controller 404. Testing may use historical data and/or field data (e.g., measurements from sensor devices 460). Testing may generate test scenarios or expected results. Testing may include the use of process chemistry simulators, fluid electrolyte modeling, chemistry calculations using field/historical data to model the process, etc.

Evaluation of the enhanced water 457 may be correlated, directly or indirectly, to whether and how much scale depositions 213 may form in the fractures 101 and rock matrices in the volume 190 of the subterranean formation 110 adjacent to the wellbore 120 when the enhanced water 457 is used in one or more field operations 465, and to how much scale precipitation may be reduced by using the enhanced water 457 for a fracturing operation or for injection into a SWD or other type of injection well compared to existing operations. In addition, or in the alternative, the enhanced water 457 may be evaluated or otherwise processed by the enhanced water processing apparatus 450. For example, in certain example embodiments, the enhanced water processing apparatus 450 may be used to alter (e.g., decrease) the pH value of the enhanced water 457 by adding one or more of a number of acid solutions (e.g., HCl), which may lower the scaling potential with respect to calcite and other types of mineral scales. The enhanced water 457 may include any of a number of gases, liquids, and/or solids after leaving the mixing apparatus 470.

In addition, or in the alternative, within the system 400, whether as stand-alone components or components that are integrated with another component (e.g., an additive injection system 438) of the system 400, the various characteristics (e.g., composition, concentration or each element or compound) of the water 447 and/or one or more of the additives 427 may be analyzed before reaching the mixing apparatus 470 (or before reaching the collection area 489 if the water 447 and one or more of the additives 427 are introduced to each other upstream of the mixing apparatus 470). In order to accomplish this, the part of the mixing apparatus 470 (or other part of the system 400) that receives the additives 427, the water 447, the combined product 437, the enhanced water 457, and/or the solids 467 may be made of any of a number of appropriate material (e.g., glass, polytetrafluoroethylene-lined stainless steel) that may withstand the conditions (e.g., pressure, temperature) simulated by the mixing apparatus 470 (or other part of the system 400).

After the combined product 437 is processed by the mixing apparatus 470, one or more solids 467 and the enhanced water 457 are among the products. Each solid 467 includes at least some of the solid-generating components (e.g., multi-valent cations) that are present in the water 447. A solid 467 may have any of a range of sizes (e.g., 5 microns to 200 microns, 2 microns (dispersed) to 600 microns (when coagulated or flocculated with additional additives 427)). Using equipment in the mixing apparatus 470 and/or stand-alone equipment, the solids 467 are separated from the enhanced water 457 and delivered, directly or indirectly, to the solid collection apparatus 475 using part of the conveyance system 488. Examples of a solid 467 may include, but are not limited to, calcium carbonate (CaCO₃), calcium/magnesium carbonate (CaₓMg₁₋ₓCO₃), barium sulfate (BaSO₄), lithium-containing compounds, and/or any other types of salts/compounds.

The optional solid processing apparatus 495 may be located between the mixing apparatus 470 and the solid collection apparatus 475 within the system 400. The solid processing apparatus 495 may be configured to provide analysis of one or more precipitated solids 467, including but not limited to Fourier transformed infrared spectroscopy (FT-IR), x-ray fluorescence (XRF), x-ray diffraction (XRD), elemental analysis, etc. The solid processing apparatus 495 may include one or more of any of a number of different equipment, including but not limited to a sifter, a shaker, a screen, a motor, a controller (e.g., controller 404), and a sensor device (e.g., sensor device 460). In some cases, the solid processing apparatus 495, or portions thereof, may operate using a controller 404. In addition, or in the alternative, one or more users 451 may perform one or more of the various functions required to operate some or all of the solid processing apparatus 495.

The solid processing apparatus 495 may include one or more of a number of different pieces of equipment to perform one or more different processing functions. Examples of such equipment and/or processing functions may include, but are not limited to, an industrial oven, heating, baking, curing, desiccation, homogenization, mechanical separation, chemical separation, magnetic separation, solvent washing, solvent purification, recrystallization, and compaction. In some cases, the solid processing apparatus 495 may modify the characteristics and/or quality of one or more solids 467 and prepare one or more of the solids 467 for use in a field operation 465-2, either involving the wellbore 120 or independent of the wellbore 120.

In some cases, the solid processing apparatus 495 may generate, isolate, separate, etc. one or more gases and/or one or more liquids when processing one or more of the solids 467. These gases and/or liquids may be used in one or more field operations 465-3 (e.g., cement for construction, building materials, construction material, concrete, acid neutralization, soil treatment, color enhancement, flooring material). In some cases, when the solid processing apparatus 495 is part of the system 400, the solid processing apparatus 495 may be bypassed. The one or more solids 467 that leave the mixing apparatus 470 are characterized as such regardless of whether those solids 467 are processed by the solid processing apparatus 495.

The solid collection apparatus 475 of the system 400 is configured to collect the solids 467 from the mixing apparatus 470, at times through the solid processing apparatus 495. If there are multiple types of solids 467, the solid collection apparatus 475 may collect all of the solids 467 collectively (in bulk) or individually (e.g., separated by type, separated by size). The solid collection apparatus 475 may include one or more of any of a number of different equipment, including but not limited to a sifter, a shaker, a screen, an immersion separator, a motor, a controller (e.g., controller 404), and a sensor device (e.g., sensor device 460).

In some cases, the solid collection apparatus 475, or portions thereof, may operate using a controller 404. In addition, or in the alternative, one or more users 451 may perform one or more of the various functions required to operate some or all of the solid collection apparatus 475. In certain example embodiments, in addition to collecting the solids 467, the solid collection apparatus 475 may include additional equipment and functionality of the solid processing apparatus 495 so that the two components of the system 400 are combined into the solid collection apparatus 475.

From the solid collection apparatus 475, the solids 467 may be conveyed, using part of the conveyance system 488, to a field operation 465-2 (e.g., another process that uses those solids 467). For example, if a solid 467 is calcium carbonate, then the solid 467 may be loaded onto a truck (part of the conveyance system 488) for delivery to a construction site (a type of field operation 465-2). In such a case, the calcium carbonate may be used as part of a cement mixture that is poured into forms and dries into concrete. In such a case, if two additives 427 are carbon dioxide and NaOH, and if the water 447 includes calcium, example embodiments may not only remove the calcium from the enhanced water 457, thereby reducing or eliminating the formation of scale depositions 213 when the enhanced water 457 is used in a fracturing operation (a type of field operation 465-1), but example embodiments may also capture carbon dioxide in the solid 467, and so also eventually into the resulting concrete, building materials, and/or other use of the solid 467.

A solid 467 (e.g., calcium carbonate) may be generated in any quantity (e.g., between approximately 20 and 70+ tons per day assuming 20,000 barrels per day of water 447 as input, between approximately 20 and 55 tons per day assuming 20,000 barrels per day of water 447 as input, between approximately 40 and 80 tons per day assuming 20,000 barrels per day of water 447 as input) using the system 400. When a solid 467 is calcium carbonate, it may be in the form of a particulate accumulating into a compacted mass (e.g., a fine (e.g., 0.1 μm to 1000 μm particle size range) white/yellow powder with a chalky consistency once dried). In such a case, the solid 467 may have a melting point that exceeds 1000° C.

In certain example embodiments, the system 400 may include an optional enhanced water processing apparatus 450 that is configured to offer further process enhancements to the enhanced water 457. For example, the enhanced water processing apparatus 450 may be configured to filter out one or more impurities, elements (e.g., lithium), compounds, gases, solids, and/or other components of a fluid. In this case, the enhanced water processing apparatus 450 is located downstream of the mixing apparatus 470 and is configured to receive the enhanced water 457 from the mixing apparatus 470 using part of the conveyance system 488 (e.g., piping).

The enhanced water processing apparatus 450 may include one or more components or pieces of equipment to perform its function. Examples of such components and pieces of equipment may include, but are not limited to, a membrane, a sifter, a shaker, a screen, an immersion separator, a reverse osmosis membrane, a nanofiltration membrane, a pH adjustment apparatus, a softening apparatus, a motor, a controller (e.g., controller 404), and a sensor device (e.g., sensor device 460). In some cases, the enhanced water processing apparatus 450, or portions thereof, may operate using a controller 404. In addition, or in the alternative, one or more users 451 (e.g., a human being) may perform some or all of the various functions required to operate some or all of the enhanced water processing apparatus 450. The enhanced water 457 that leaves the mixing apparatus 470 is characterized as such regardless of whether the enhanced water 457 is processed by the enhanced water processing apparatus 450.

When the enhanced water 457 leaves the enhanced water processing apparatus 450, it is conveyed, using part of the conveyance system 488, to one or more field operations 465-1 (e.g., a subsurface fracturing operation, injection into a SWD well). In some cases, on the way to the field operation 465-1, the enhanced water 457 may undergo one or more additional processes (e.g., mixing with proppant, chemicals, and/or other fracturing compounds, mixing with disposal compounds, additional filtering, etc.). If the system 400 does not include the enhanced water processing apparatus 450, then the enhanced water 457 leaving the mixing apparatus 470 is conveyed toward the field operation 465-1 using part of the conveyance system 488.

The one or more field operations 465-1 that receive the enhanced water 457 may be subterranean (e.g., use in fracturing fluid for fracturing of a wellbore, use in injection fluid in an injection well). The one or more field operations 465-1 may additionally or alternatively receive byproducts (e.g., one or more gases, one or more other liquids), aside from the enhanced water 457, of the mixing apparatus 470 and/or the enhanced water processing apparatus 450. The field operations 465-1 may receive the enhanced water 457 and/or other fluids using part of the conveyance system 488.

In certain example embodiments, rather than being sent to a field operation 465-1, the enhanced water 457 is subjected to testing that simulates certain conditions (e.g., subsurface conditions) that may be expected in a field operation 465-1. For example, testing may be conducted to determine the reaction of the enhanced water 457 with scales, fines, solids, rock, proppant, the formation water (a form of water 447), synthetic brines that are representative of the formation water, scale inhibitors, and/or other chemicals and/or materials. Such testing may also include particle size analysis and/or other types of analysis of scale depositions 213 in the enhanced water 457. Such testing may characterize the fluid chemistry and the solid phase of the enhanced water 457. Characterization methods may include, but are not limited to, ICP-OES, IC, titration, SEM/EDS, XRD, QXRD, pH measurements, and spectroscopy. The testing may further include one or more compatibility tests on the enhanced water 457 for different purposes, including but not limited to optimizing a fracturing operation and optimizing injection well performance. Such compatibility tests may include, but are not limited to, fluid-rock-chemical compatibility tests and comparability tests of the enhanced water 457 with scale inhibitors, water, oil, fluids, and/or chemicals injected into the volume 190 of the subterranean formation 110.

For example, for treatment of the volume 190 using a particular (e.g., recommended) fracturing fluid that includes the enhanced water 457 during fracturing at a completion stage of a field operation 465-1, compatibility tests may include, but are not limited to, a mixture of the enhanced water 457 and crude oil (or other subterranean resource 111) with rock, a mixture of the enhanced water 457 and crude oil (or other subterranean resource 111) without rock, a mixture of the enhanced water 457 and displacement fluid with rock, a mixture of the enhanced water 457 and displacement fluid without rock, a mixture of the enhanced water 457 and the fracturing fluid with rock, a mixture of the enhanced water 457 and the fracturing fluid without rock, a mixture of the enhanced water 457 and the water 447 with rock, a mixture of the enhanced water 457 and the water 447 without rock, a mixture of the enhanced water 457 and a completion brine with rock, and a mixture of the enhanced water 457 and a completion brine without rock.

As another example, for treatment of the volume 190 using a fluid (e.g., a recommended fluid) that includes the enhanced water 457 for production enhancement during the production stage of a field operation 465-1, compatibility tests may include, but are not limited to, a mixture of the enhanced water 457 and crude oil (or other subterranean resource 111) with rock, a mixture of the enhanced water 457 and crude oil (or other subterranean resource 111) without rock, a mixture of the enhanced water 457 and the production water 447 with rock, a mixture of the enhanced water 457 and the production water 447 without rock, a mixture of the enhanced water 457 and a completion brine with rock, and a mixture of the enhanced water 457 and a completion brine without rock.

As yet another example, for treatment of the volume 190 using a fluid (e.g., a recommended) that includes the enhanced water 457 for well injectivity enhancement of a field operation 465-1, compatibility tests may include, but are not limited to, a mixture of the enhanced water 457 and the injection water with rock, a mixture of the enhanced water 457 and the injection water without rock, a mixture of the enhanced water 457 and the production water 447 with rock, and a mixture of the enhanced water 457 and the production water 447 without rock.

In certain example embodiments, one or more additives 427 may be added to the enhanced water 457. In such cases, the resulting combination may be put through the mixing apparatus 470 (or portion thereof) and/or the enhanced water processing apparatus 450 (or portion thereof) for new and/or additional separation of solids 467 and/or processing of the resulting enhanced water 457. This additional mixing and/or processing of the enhanced water 457 may occur multiple times. As an example, as when the enhanced water 457 is configured to be used as an injection fluid for an injection well, the one or more additives 427 may be added to the enhanced water 457 in the mixing apparatus 470. Subsequently, the enhanced water processing apparatus 450 may perform one or more tests (e.g., tests for concentration of biocide, chemical-water compatibility tests) on the resulting enhanced water 457 to determine if further additives and/or processing of the enhanced water 457 is needed for its intended purpose in a field operation 465-1.

Based on the compatibility tests and other analysis of the enhanced water 457, one or more integrated tests on the enhanced water 457 (or components thereof) may be conducted. Such integrated tests may result in determining what may react, be dissolved, and/or be mobilized and in determining reaction/interaction kinetics. This information may help to assess the impact (e.g., scale modeling results for fluid comingling scenarios) of the enhanced water 457 (or components thereof) on scale, asphaltene, and/or other types of accumulations on the volume 190 in the subterranean formation 110 during well intervention, shutting in, and/or post-treatment production.

References for scale modeling and lab tests include an article titled “Scale Formation and Inhibition Study for Water Injection Wells” by Wang, W., Wei, W., Ferrier, N., and Arismendi, N., published in 2018 by the Society of Petroleum Engineers, and an article titled “Scaling Control for High Temperature and Pressure Oil Production” by Wang, W., Kan, A. T., Shi, W., Fan, C., and Tomson, M., published in 2013 in Mineral Scales in Biological and Industrial Systems, ed. Z. Amjad, Chap. 5, 77-102. Boca Raton, Florida: CRC Press. Examples of equipment that may be used in the mixing apparatus 470, the enhanced water processing apparatus 450, and/or the solid processing apparatus 495 may be found, for example, in U.S. Patent Application Publication No. 2019/0299162 to Chen and published on Oct. 3, 2019, in U.S. Patent Application Publication No. 2015/0376033 to Tao et al. and published on Dec. 31, 2015, and in U.S. Pat. No. 10,906,001 to Chen and patented on Feb. 2, 2021. All of these references in their entirety are hereby incorporated by reference herein.

Similar testing and analysis may be performed on the solids 467 that result from mixing the water 447 and the additives 427 together in the mixing apparatus 470. The results integration and analysis may help determine an optimized type and concentration of additives 427 to be used. The testing may set and/or adjust the design and/or field treatment protocols of the volume 190 using enhanced water 457 to optimize the efficiency of a field operation 465-1 (e.g., improving well production performance). The testing may additionally consider the results from standard industry tests (e.g., re-gained permeability from core-flood tests) and other factors in determining well optimization. Well optimization may apply to one or more stages of a field operation 465, including but not limited to fluid (e.g., acid) treatment of fractures 101 at the completion stage of fracturing, fluid treatment as a job for scales or fines removal, treatment using the enhanced water 457 for production enhancement during the production stage, a shut-in stage, and for SWD well injectivity enhancement.

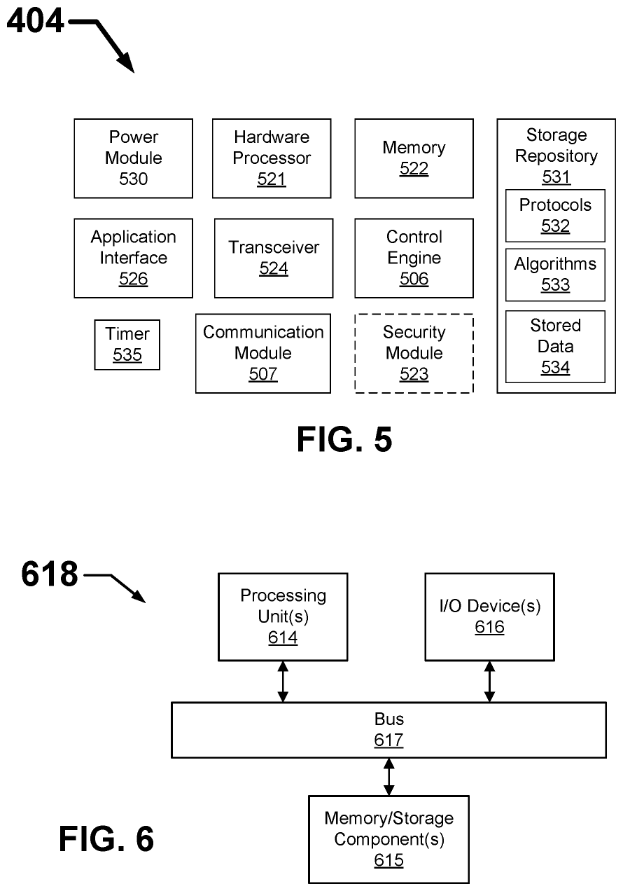

The system 400 may include one or more controllers 404. A controller 404 of the system 400 communicates with and in some cases controls one or more of the other components (e.g., a sensor device 460, a water injection system 449, an additive injection system 438, the mixing apparatus 470, the solid collection apparatus 475, the enhanced water processing apparatus 450) of the system 400. A controller 404 performs any of a number of functions that include obtaining and sending data, evaluating data, following protocols, running algorithms, and sending commands. A controller 404 may include one or more of a number of components. As discussed below with respect to FIG. 5, such components of a controller 404 may include, but are not limited to, a control engine, a communication module, a timer, a counter, a power module, a storage repository, a hardware processor, memory, a transceiver, an application interface, and a security module.

When there are multiple controllers 404 (e.g., one controller 404 for one or more additive injection systems 438, another controller 404 for the mixing apparatus 470, yet another controller 404 for the solid collection apparatus 475, still another for one or more water injection systems 449), each controller 404 may operate independently of each other. Alternatively, two or more of the multiple controllers 404 may work cooperatively with each other. As yet another alternative, one of the controllers 404 may control some or all of one or more other controllers 404 in the system 400. Each controller 404 may be considered a type of computer device, as discussed below with respect to FIG. 6.

Each sensor device 460 includes one or more sensors that measure one or more parameters (e.g., pressure, flow rate, temperature, humidity, fluid content, voltage, current, permeability, porosity, rock characteristics, chemical elements in a fluid, chemical elements in a solid, concentrations, etc.). Examples of a sensor of a sensor device 460 may include, but are not limited to, a temperature sensor, a flow sensor, a pressure sensor, a gas spectrometer, a voltmeter, an ammeter, a permeability meter, a spectrograph, a gas chromatograph a porosimeter, and a camera. A sensor device 460 may be a stand-alone device or integrated with another component of the system 400.

A parameter measured by a sensor device 460 may be associated with one or more components of the system 400. For example, a sensor device 460 may be configured to measure a parameter (e.g., flow rate, pressure, temperature, composition, concentration) of water 447, an additive 427, the combined product 437, a solid 467, and/or the enhanced water 457 at any location (e.g., between a water source 448 and a corresponding water injection system 449, between an additive source 428 and a corresponding additive injection system 438, between the collection area 489 and the mixing apparatus 470, between the mixing apparatus 470 and the solid collection apparatus 475, within a portion of the mixing apparatus 470, within a portion of the enhanced water processing apparatus 450, within a portion of the solid processing apparatus 495, etc.) of the system 400 at a particular time.

As another example, a sensor device 460 may be configured to determine how open or closed a valve 485 within the system 400 is. As yet another example, one or more sensor devices 460 may be used to identify the contents of a solid 467 and the concentration of each of the contents within the solid 467. As still another example, one or more sensor devices 460 may be used to identify the contents of the enhanced water 457 and/or the concentration of each of the contents within the enhanced water 457. As yet another example, one or more sensor devices 460 may be used to identify the contents of the water 447 and/or the concentration of each of the contents within the water 447.

In some cases, a number of sensor devices 460, each measuring a different parameter, may be used in combination to determine and confirm whether a controller 404 should take a particular action (e.g., operate a valve 485, operate or adjust the operation of the mixing apparatus 470). When a sensor device 460 includes its own controller 404 (or portions thereof), then the sensor device 460 may be considered a type of computer device, as discussed below with respect to FIG. 6.

A user 451 may be any person that interacts, directly or indirectly, with a controller 404 and/or any other component of the testing system 400. Examples of a user 451 may include, but are not limited to, a business owner, an engineer, a company representative, a geologist, a consultant, a drilling engineer, a contractor, and a manufacturer's representative. A user 451 may use one or more user systems 455, which may include a display (e.g., a GUI). A user system 455 of a user 451 may interact with (e.g., send data to, obtain data from) the controller 404 via an application interface and using the communication links 405. The user 451 may also interact directly with the controller 404 through a user interface (e.g., keyboard, mouse, touchscreen).

The network manager 480 is a device or component that controls all or a portion (e.g., a communication network, the controller 404) of the system 400. The network manager 480 may be substantially similar to the controller 404, as described above. For example, the network manager 480 may include a controller that has one or more components and/or similar functionality to some or all of the controller 404. Alternatively, the network manager 480 may include one or more of a number of features in addition to, or altered from, the features of the controller 404. As described herein, control and/or communication with the network manager 480 may include communicating with one or more other components of the same system 400 or another system. In such a case, the network manager 480 may facilitate such control and/or communication. The network manager 480 may be called by other names, including but not limited to a master controller, a network controller, and an enterprise manager. The network manager 480 may be considered a type of computer device, as discussed below with respect to FIG. 6.

Interaction between each controller 404, the sensor devices 460, the users 451 (including any associated user systems 455), the network manager 480, and other components (e.g., the valves 485, a produced water injection system 449, an additive injection system 438, the mixing apparatus 470, the solid collection apparatus 475) of the system 400 may be conducted using communication links 405 and/or power transfer links 487. Each communication link 405 may include wired (e.g., Class 1 electrical cables, Class 2 electrical cables, electrical connectors, Power Line Carrier, RS485) and/or wireless (e.g., Wi-Fi, Zigbee, visible light communication, cellular networking, Bluetooth, Bluetooth Low Energy (BLE), ultrawide band (UWB), WirelessHART, ISA100) technology. A communication link 405 may transmit signals (e.g., communication signals, control signals, data) between each controller 404, the sensor devices 460, the users 451 (including any associated user systems 455), the network manager 480, and the other components of the system 400.

Each power transfer link 487 may include one or more electrical conductors, which may be individual or part of one or more electrical cables. In some cases, as with inductive power, power may be transferred wirelessly using power transfer links 487. A power transfer link 487 may transmit power between each controller 404, the sensor devices 460, the users 451 (including any associated user systems 455), the network manager 480, and the other components of the system 400. Each power transfer link 487 may be sized (e.g., 12 gauge, 18 gauge, 4 gauge) in a manner suitable for the amount (e.g., 480V, 24V, 120V) and type (e.g., alternating current, direct current) of power transferred therethrough.

FIG. 5 shows a system diagram of a controller 404 according to certain example embodiments. Referring to FIGS. 1A through 5, the controller 404 may be substantially the same as a controller 404 discussed above with respect to FIG. 4. The controller 404 includes multiple components. In this case, the controller 404 of FIG. 5 includes a control engine 506, a communication module 507, a timer 535, a power module 530, a storage repository 531, a hardware processor 521, a memory 522, a transceiver 524, an application interface 526, and, optionally, a security module 523. A controller 404 (or components thereof) may be located at or near the various components of the system 400. In addition, or in the alternative, the controller 404 (or components thereof) may be located remotely from (e.g., in the cloud, at an office building) the various components of the system 400.

The storage repository 531 may be a persistent storage device (or set of devices) that stores software and data used to assist the controller 404 in communicating with one or more other components of a system, such as the users 451 (including associated user systems 455), each water injection system 449, each additive injection system 438, the mixing apparatus 470, each enhanced water processing apparatus 450, the solid collection apparatus 475, the network manager 480, the sensor devices 460, etc. of the system 400 of FIG. 4 above. In one or more example embodiments, the storage repository 531 stores one or more protocols 532, algorithms 533, and stored data 534.

The protocols 532 of the storage repository 531 may be any procedures (e.g., a series of method steps) and/or other similar operational processes that the control engine 506 of the controller 404 follows based on certain conditions at a point in time. The protocols 532 may include any of a number of communication protocols that are used to send and/or obtain data between the controller 404 and other components of a system (e.g., the system 400). Such protocols 532 used for communication may be time-synchronized protocols. Examples of such time-synchronized protocols may include, but are not limited to, a highway addressable remote transducer (HART) protocol, a wirelessHART protocol, and an International Society of Automation (ISA) 100 protocol. In this way, one or more of the protocols 532 may provide a layer of security to the data transferred within a system (e.g., the system 400). Other protocols 532 used for communication may be associated with the use of Wi-Fi, Zigbee, visible light communication (VLC), cellular networking, BLE, UWB, and Bluetooth.

The algorithms 533 may be any formulas, mathematical models, forecasts, simulations, and/or other similar tools that the control engine 506 of the controller 404 uses to reach a computational conclusion. For example, one or more algorithms 533 may be used, in conjunction with one or more protocols 532, to assist the controller 404 to determine when to start, adjust, and/or stop the operation of the mixing apparatus 470, a water injection system 449, an additive injection system 438, the solid collection apparatus 475, and/or the enhanced water processing apparatus 450. As another example, one or more algorithms 533 may be used, in conjunction with one or more protocols 532, to assist the controller 404 to determine when to have a sensor device 460 measure a parameter and subsequently perform a calculation or make a determination using the measurement.

As yet another example, one or more algorithms 533 may be used, in conjunction with one or more protocols 532, to assist the controller 404 to identify an optimal (e.g., most cost effective, most likely to solidify a solid-generating component of the water 447) or recommended additive 427 based on the composition of the water 447. As still another example, one or more algorithms 533 may be used, in conjunction with one or more protocols 532, to assist the controller 404 in identifying the composition of the enhanced water 457 and evaluating the actual composition of the enhanced water 457 against the anticipated composition of the enhanced water 457.

Stored data 534 may be any data associated with a field (e.g., the subterranean formation 110, the fractures 101 within the volume 190 adjacent to a wellbore 120, the characteristics of proppant 112 used in a field operation 465, composition of the water 447), other fields (e.g., other wellbores and subterranean formations), the other components (e.g., the user systems 455, the mixing apparatus 470, the additives 427, the solid collection apparatus 475), including associated equipment (e.g., motors, pumps, compressors), of the system 400, measurements made by the sensor devices 460, threshold values, tables, results of previously run or calculated algorithms 533, updates to protocols 532, user preferences, and/or any other suitable data. Such data may be any type of data, including but not limited to historical data, present data, and future data (e.g., forecasts). The stored data 534 may be associated with some measurement of time derived, for example, from the timer 535.

Examples of a storage repository 531 may include, but are not limited to, a database (or a number of databases), a file system, cloud-based storage, a hard drive, flash memory, some other form of solid-state data storage, or any suitable combination thereof. The storage repository 531 may be located on multiple physical machines, each storing all or a portion of the communication protocols 532, the algorithms 533, and/or the stored data 534 according to some example embodiments. Each storage unit or device may be physically located in the same or in a different geographic location.

The storage repository 531 may be operatively connected to the control engine 506. In one or more example embodiments, the control engine 506 includes functionality to communicate with the users 451 (including associated user systems 455), the sensor devices 460, the network manager 480, and the other components in the system 400. More specifically, the control engine 506 sends information to and/or obtains information from the storage repository 531 in order to communicate with the users 451 (including associated user systems 455), the sensor devices 460, the network manager 480, and the other components of the system 400. As discussed below, the storage repository 531 may also be operatively connected to the communication module 507 in certain example embodiments.

In certain example embodiments, the control engine 506 of the controller 404 controls the operation of one or more components (e.g., the communication module 507, the timer 535, the transceiver 524) of the controller 404. For example, the control engine 506 may activate the communication module 507 when the communication module 507 is in “sleep” mode and when the communication module 507 is needed to send data obtained from another component (e.g., a sensor device 460) in the system 400. In addition, the control engine 506 of the controller 404 may control the operation of one or more other components (e.g., the mixing apparatus 470, the solid collection apparatus 475, a water injection system 449, an additive injection system 438), or portions thereof, of the system 400.

The control engine 506 of the controller 404 may communicate with one or more other components of the system 400. For example, the control engine 506 may use one or more protocols 532 to facilitate communication with the sensor devices 460 to obtain data (e.g., measurements of various parameters, such as temperature, pressure, and flow rate), whether in real time or on a periodic basis and/or to instruct a sensor device 460 to take a measurement. The control engine 506 may use measurements of parameters taken by sensor devices 460 while the combined product 437 is being processed by the mixing apparatus 470, as well as one or more protocols 532 and/or algorithms 533, to analyze the contents of the enhanced water 457.

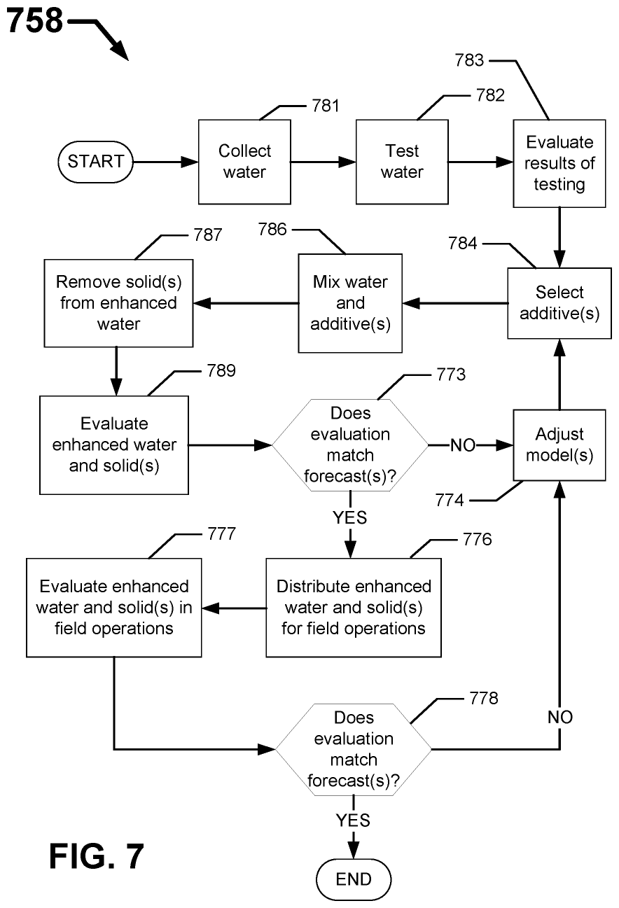

As yet another example, the control engine 506 may use one or more algorithms 533 and/or protocols 532 to recommend a change to the formulation (e.g., adding an additive 427, removing an additive 427, swapping one additive 427 for another additive 427, altering the composition and/or source of the water 447, increasing an amount (concentration) of an additive 427, decreasing an amount of an additive 427) of the combined product 437, based on the analysis of the enhanced water 457 and any solids 467, in an attempt to optimize available resources and economics in a particular stage of a field operation 465. A number of other capabilities of the control engine 506 (as well as the controller 404 as a whole) are discussed below with respect to FIG. 7.

The control engine 506 may generate and process data associated with control, communication, and/or other signals sent to and obtained from the users 451 (including associated user systems 455), the sensor devices 460, the network manager 480, and the other components of the system 400. In certain embodiments, the control engine 506 of the controller 404 may communicate with one or more components of a system external to the system 400. For example, the control engine 506 may interact with an inventory management system by ordering replacements for components or pieces of equipment (e.g., a sensor device 460, a valve 485, a motor) within the system 400 that has failed or is failing. As another example, the control engine 506 may interact with a contractor or workforce scheduling system by arranging for the labor needed to replace a component or piece of equipment in the system 400. In this way and in other ways, the controller 404 is capable of performing a number of functions beyond what could reasonably be considered a routine task.

In certain example embodiments, the control engine 506 may include an interface that enables the control engine 506 to communicate with the sensor devices 460, the user systems 455, the network manager 480, and/or other components of the system 400. For example, if a user system 455 operates under IEC Standard 62386, then the user system 455 may have a serial communication interface that will transfer data to the controller 404. Such an interface may operate in conjunction with, or independently of, the protocols 532 used to communicate between the controller 404 and the users 451 (including corresponding user systems 455), the sensor devices 460, the network manager 480, and the other components of the system 400.

The control engine 506 (or other components of the controller 404) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 507 of the controller 404 determines and implements the communication protocol (e.g., from the protocols 532 of the storage repository 531) that is used when the control engine 506 communicates with (e.g., sends signals to, obtains signals from) the user systems 455, the sensor devices 460, the network manager 480, and the other components of the system 400. In some cases, the communication module 507 accesses the stored data 534 to determine which communication protocol is used to communicate with another component of the system 400. In addition, the communication module 507 may identify and/or interpret the communication protocol of a communication obtained by the controller 404 so that the control engine 506 may interpret the communication. The communication module 507 may also provide one or more of a number of other services with respect to data sent from and obtained by the controller 404. Such services may include, but are not limited to, data packet routing information and procedures to follow in the event of data interruption.

The timer 535 of the controller 404 may track clock time, intervals of time, an amount of time, and/or any other measure of time. The timer 535 may also count the number of occurrences of an event, whether with or without respect to time. Alternatively, the control engine 506 may perform a counting function. The timer 535 is able to track multiple time measurements and/or count multiple occurrences concurrently. The timer 535 may track time periods based on an Instruction obtained from the control engine 506, based on an instruction obtained from a user 451, based on an instruction programmed in the software for the controller 404, based on some other condition (e.g., the occurrence of an event) or from some other component, or from any combination thereof. In certain example embodiments, the timer 535 may provide a time stamp for each packet of data obtained from another component (e.g., a sensor device 460) of the system 400.

The power module 530 of the controller 404 obtains power from a power supply (e.g., AC mains) and manipulates (e.g., transforms, rectifies, inverts) that power to provide the manipulated power to one or more other components (e.g., the timer 535, the control engine 506) of the controller 404, where the manipulated power is of a type (e.g., alternating current, direct current) and level (e.g., 12V, 24V, 120V) that may be used by the other components of the controller 404. In some cases, the power module 530 may also provide power to one or more of the sensor devices 460.

The power module 530 may include one or more of a number of single or multiple discrete components (e.g., transistor, diode, resistor, transformer) and/or a microprocessor. The power module 530 may include a printed circuit board, upon which the microprocessor and/or one or more discrete components are positioned. In addition, or in the alternative, the power module 530 may be a source of power in itself to provide signals to the other components of the controller 404. For example, the power module 530 may be or include an energy storage device (e.g., a battery). As another example, the power module 530 may be or include a localized photovoltaic power system.

The hardware processor 521 of the controller 404 executes software, algorithms (e.g., algorithms 533), and firmware in accordance with one or more example embodiments. Specifically, the hardware processor 521 may execute software on the control engine 506 or any other portion of the controller 404, as well as software used by the users 451 (including associated user systems 455), the network manager 480, and/or other components of the system 400. The hardware processor 521 may be an integrated circuit, a central processing unit, a multi-core processing chip, SoC, a multi-chip module including multiple multi-core processing chips, or other hardware processor in one or more example embodiments. The hardware processor 521 may be known by other names, including but not limited to a computer processor, a microprocessor, and a multi-core processor.

In one or more example embodiments, the hardware processor 521 executes software instructions stored in memory 522. The memory 522 includes one or more cache memories, main memory, and/or any other suitable type of memory. The memory 522 may include volatile and/or non-volatile memory. The memory 522 may be discretely located within the controller 404 relative to the hardware processor 521. In certain configurations, the memory 522 may be integrated with the hardware processor 521.

In certain example embodiments, the controller 404 does not include a hardware processor 521. In such a case, the controller 404 may include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 404 (or portions thereof) to be programmable and function according to certain logic rules and thresholds without the use of a hardware processor. Alternatively, FPGAs, IGBTs, ICs, and/or similar devices may be used in conjunction with one or more hardware processors 521.

The transceiver 524 of the controller 404 may send and/or obtain control and/or communication signals. Specifically, the transceiver 524 may be used to transfer data between the controller 404 and the users 451 (including associated user systems 455), the sensor devices 460, the network manager 480, and the other components of the system 400. The transceiver 524 may use wired and/or wireless technology. The transceiver 524 may be configured in such a way that the control and/or communication signals sent and/or obtained by the transceiver 524 may be obtained and/or sent by another transceiver that is part of a user system 455, a sensor device 460, the network manager 480, and/or another component of the system 400. The transceiver 524 may send and/or obtain any of a number of signal types, including but not limited to radio frequency signals.

When the transceiver 524 uses wireless technology, any type of wireless technology may be used by the transceiver 524 in sending and obtaining signals. Such wireless technology may include, but is not limited to, Wi-Fi, Zigbee, VLC, cellular networking, BLE, UWB, and Bluetooth. The transceiver 524 may use one or more of any number of suitable communication protocols (e.g., ISA100, HART) when sending and/or obtaining signals.

Optionally, in one or more example embodiments, the security module 523 secures interactions between the controller 404, the users 451 (including associated user systems 455), the sensor devices 460, the network manager 480, and the other components of the system 400. More specifically, the security module 523 authenticates communication from software based on security keys verifying the identity of the source of the communication. For example, user software may be associated with a security key enabling the software of a user system 455 to interact with the controller 404. Further, the security module 523 may restrict receipt of information, requests for information, and/or access to information.

A user 451 (which may include an associated user system 455), the sensor devices 460, the network manager 480, and the other components of the system 400 may interact with the controller 404 using the application interface 526. Specifically, the application interface 526 of the controller 404 obtains data (e.g., information, communications, instructions, updates to firmware) from and sends data (e.g., information, communications, instructions) to the user systems 455 of the users 451, the sensor devices 460, the network manager 480, and/or the other components of the system 400. Examples of an application interface 526 may be or include, but are not limited to, an application programming interface, a web service, a data protocol adapter, some other hardware and/or software, or any suitable combination thereof. Similarly, the user systems 455 of the users 451, the sensor devices 460, the network manager 480, and/or the other components of the system 400 may include an interface (similar to the application interface 526 of the controller 404) to obtain data from and send data to the controller 404 in certain example embodiments.

In addition, as discussed above with respect to a user system 455 of a user 451, one or more of the sensor devices 460, the network manager 480, and/or one or more of the other components of the system 400 may include a user interface. Examples of such a user interface may include, but are not limited to, a graphical user interface, a touchscreen, a keyboard, a monitor, a mouse, some other hardware, or any suitable combination thereof.

The controller 404, the users 451 (including associated user systems 455), the sensor devices 460, the network manager 480, and the other components of the system 400 may use their own system or share a system in certain example embodiments. Such a system may be, or contain a form of, an Internet-based or an intranet-based computer system that is capable of communicating with various software. A computer system includes any type of computing device and/or communication device, including but not limited to the controller 404. Examples of such a system may include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system may correspond to a computer system as described below with regard to FIG. 6.

Further, as discussed above, such a system may have corresponding software (e.g., user system software, sensor device software, controller software). The software may execute on the same or a separate device (e.g., a server, mainframe, desktop personal computer (PC), laptop, PDA, television, cable box, satellite box, kiosk, telephone, mobile phone, or other computing devices) and may be coupled by the communication network (e.g., Internet, Intranet, Extranet, LAN, WAN, or other network communication methods) and/or communication channels, with wire and/or wireless segments according to some example embodiments. The software of one system may be a part of, or operate separately but in conjunction with, the software of another system within the system 400.

FIG. 6 illustrates one embodiment of a computing device 618 that implements one or more of the various techniques described herein, and which is representative, in whole or in part, of the elements described herein pursuant to certain example embodiments. For example, a controller 404 (including components thereof, such as a control engine 506, a hardware processor 521, a storage repository 531, a power module 530, and a transceiver 524) may be considered a computing device 618 (also called a computer system 618 herein). Computing device 618 is one example of a computing device and is not intended to suggest any limitation as to scope of use or functionality of the computing device and/or its possible architectures. Neither should the computing device 618 be interpreted as having any dependency or requirement relating to any one or combination of components illustrated in the example computing device 618.

The computing device 618 includes one or more processors or processing units 614, one or more memory/storage components 615, one or more input/output (I/O) devices 616, and a bus 617 that allows the various components and devices to communicate with one another. The bus 617 represents one or more of any of several types of bus structures, including a memory bus or memory controller, a peripheral bus, an accelerated graphics port, and a processor or local bus using any of a variety of bus architectures. The bus 617 includes wired and/or wireless buses.

The memory/storage component 615 represents one or more computer storage media. The memory/storage component 615 includes volatile media (such as random access memory (RAM)) and/or nonvolatile media (such as read only memory (ROM), flash memory, optical disks, magnetic disks, and so forth). The memory/storage component 615 includes fixed media (e.g., RAM, ROM, a fixed hard drive, etc.) as well as removable media (e.g., a Flash memory drive, a removable hard drive, an optical disk, and so forth).

One or more I/O devices 616 allow a user 451 to enter commands and information to the computing device 618, and also allow information to be presented to the user 451 and/or other components or devices. Examples of input devices 616 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 618 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 618 includes at least the minimal processing, input, and/or output means necessary to practice one or more embodiments.

Further, those skilled in the art will appreciate that one or more elements of the aforementioned computer device 618 is located at a remote location and connected to the other elements over a network in certain example embodiments. Further, one or more embodiments is implemented on a distributed system having one or more nodes, where each portion of the implementation (e.g., a water injection system 438, the mixing apparatus 470, the solid collection apparatus 475) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

FIG. 7 shows a flowchart 758 of a method for enhancing water 447 for improved well performance according to certain example embodiments. While the various steps in this flowchart 758 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order. Some or all of the steps of the method of FIG. 7 may be performed off site (e.g., in a laboratory remote from a field operation). In addition, or in the alternative, some or all of the steps of the method of FIG. 7 may be performed on site (e.g., in the field, adjacent to a wellbore 120) where a field operation is being performed or planned.

In addition, a person of ordinary skill in the art will appreciate that additional steps not shown in FIG. 7 may be included in performing this method. Accordingly, the specific arrangement of steps should not be construed as limiting the scope. Further, a particular computing device, such as the computing device 618 discussed above with respect to FIG. 6, may be used to perform one or more of the steps for the methods shown in FIG. 7 in certain example embodiments. Any of the functions performed below by a controller 404 (an example of which is shown in FIG. 5) may involve the use of one or more protocols 532, one or more algorithms 533, and/or stored data 534 stored in a storage repository 531. In addition, or in the alternative, any of the functions in the method may be performed by a user (e.g., user 451).

The method shown in FIG. 7 is merely an example that may be performed by using an example system described herein. In other words, systems for enhancing water 447 for improved well performance may perform other functions using other methods in addition to and/or aside from those shown in FIG. 7. Referring to FIGS. 1A through 7, the method shown in the flowchart 758 of FIG. 7 begins at the START step and proceeds to step 781, where water 447 is collected. The water 447 may be collected from one or more water sources 448. For example, the water 447 may be extracted from a wellbore 120 (a type of water source 448) during a part (e.g., an exploration part) of a field operation 465. The water 447 may be collected at the surface (e.g., surface 108, surface 208) using field equipment 109, part of the conveyance system 488, and/or other equipment (e.g., pumps, compressors). Some or all of the process of collecting the water 447 may be controlled by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of collecting the water 447 may be controlled by a user 451. The water 447 may be collected continuously over an extended period of time or on an iterative basis.

In step 782, the water 447 is tested. Testing of the water 447 may be conducted using one or more sensor devices 460 to measure one or more parameters that are directly or indirectly associated with the water 447. The water 447 may be tested at the surface (e.g., surface 108, surface 208). The water 447 may be tested for one or more of any of a number of characteristics, including but not limited to the composition of the water 447, the amount (concentration) of each part of the composition, the amount and type of TDSs in the water 447, the state (e.g., liquid, solid) of each part of the composition, temperature, and viscosity. Some or all of the process of testing the water 447 may be controlled by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of testing the water 447 may be controlled by a user 451. The water 447 may be tested continuously over an extended period of time or on a discrete basis.

In addition to testing the water 447, other elements aside from the water 447 may be tested. For example, compositions (e.g., chemistry of the water 447, concentration of dissolved cations and anions) and/or properties (e.g., porosity, permeability) of rock in a SWD well and/or a production wellbore 120 may be tested. As another example, rock and other aspects of a wellbore that are directly or indirectly related to a field operation 465 may be tested. Each of the aspects of these other elements that are tested may be directly related to, indirectly related to, or unrelated to the water 447 and targeting field operations 465 (e.g., performance of a hydraulic fracturing operation, injection into an injection well).

In some cases, the water 447 may be processed before being tested and/or after being tested. In the latter case, the water 447 may be retested after being processed. The water 447 may be processed multiple times and/or tested multiple times. The water 447 may be processed for any of a number of purposes, including but not limited to removing cuttings and other unwanted solids, changing the pH, and adding chemicals. The processed water 447 may be processed using any of a number of appropriate equipment, including but not limited to heaters, chillers, mixers, filters, agitators, pumps, and centrifuges.

In step 783, the results of the tests on the water 447 are evaluated. Some or all of the results may be evaluated by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of evaluating the results may be controlled by a user 451. The results may include raw measurements made by sensor devices 460, adjusted measurements made by sensor devices 460, outputs of models using measurements made by sensor devices 460 as inputs, some other information associated with measurements made by sensor devices 460, or any suitable combination thereof.

In some cases, evaluating the results of the tests on the water 447 may include developing strategies and forecasts that may be used in one or more steps below (e.g., step 784, step 786). Chemistry calculations based on the evaluated results of this step 783 may be performed. In addition to modeling, lab testing and/or other evaluation methods may be used to evaluate the results of the tests on the water 447. Evaluating the results of the tests on the water 447 may be performed at the surface (e.g., surface 108, surface 208).

The results may be evaluated continuously over an extended period of time or on a discrete basis. The results of the tests may be evaluated against historical data, other present data, and/or forecasts. The results of the tests may be evaluated against data for the particular wellbore 120 from which the water 447 is extracted, for other adjacent wells that are part of the same pad, upcoming wells in a targeted formation, and/or for other wells (e.g., a SWD well) in other locations. In certain example embodiments, in addition to the results of the tests on the water 447 being evaluated, the results of other elements that may have been tested in step 782 may be evaluated. In any case, the evaluation may be in terms of chemistry, economics, some other factor, or any suitable combination thereof.

In step 784, one or more additives 427 are selected. Each additive 427 may be selected based on the results evaluated in step 783 or in step 774 (discussed below). If this step 784 represents a repeated step in the method, then selecting an additive 427 may include selecting a new additive 427 in place of a previously-selected additive 427 and/or selecting a different concentration or amount of an additive 427 compared to a concentration or amount previously selected for that additive 427. Each additive 427 may be selected at the surface (e.g., surface 108, surface 208).

Some or all of the process of selecting the one or more additives 427 may be controlled by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of selecting one or more of the additives 427 may be controlled by a user 451. The selection of the one or more additives 427 may be made based on expected results of using those one or more additives 427 in combination with the water 447 for a subterranean field operation 465.

In step 786, the water 447 and one or more of the additives 427 are mixed together. Each additive 427 may be removed from an additive source 428 using an additive injection system 438 and part of the conveyance system 488. The water 447 may be removed from one or more water sources 448 using one or more water injection systems 449 and another part of the conveyance system 488. The water 447 and the one or more additives 427 may be mixed at the surface (e.g., surface 108, surface 208) using the mixing apparatus 470.

The water 447 and one or more of the additives 427 may be separated from each other until entering the mixing apparatus 470. Alternatively, the water 447 and one or more of the additives 427 may form a combined product 437 in the collection area 489 before reaching the mixing apparatus 470. Some or all of the process of mixing the water 447 and the one or more additives 427 may be controlled by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of mixing the water 447 and the one or more additives 427 may be controlled by a user 451.

In step 787, one or more solids 467 are removed (e.g., separated) from the enhanced water 457. As discussed above, the solids 467 and the enhanced water 457 are byproducts of mixing the water 447 and one or more of the additives 427 together. The enhanced water 457 differs from the water 447 by lacking, or having a significantly reduced amount of, one or more elements and/or compounds (e.g., multi-valent cations) relative to the water 447. The one or more solids 467 may be separated from the enhanced water 457 at the surface (e.g., surface 108, surface 208) using equipment (e.g., separators, filters, centrifuges) within the mixing apparatus 470 or downstream of the mixing apparatus 470.

Once the one or more solids 467 are separated from the enhanced water 457, part of the conveyance system 488 may take the one or more solids 467 to the solid collection apparatus 475. In some such cases, the conveyance system 488 may take one or more of the solids 467 to the optional solid processing apparatus 495, and then taking the solids 467 output from the solid processing apparatus 495 to the solid collection apparatus 475. As discussed above, the solid processing apparatus 495 may be used to evaluate, test, enhance, and/or otherwise process one or more of the solids 467 that leave the mixing apparatus 470.

Another part of the conveyance system 488 may take the enhanced water 457 to an optional enhanced water processing apparatus 450 for further enhancing. Alternatively, another part of the conveyance system 488 may take the enhanced water 457 toward a field operation 465-1 (e.g., fracturing of the wellbore 120, for use in a SWD well). If the optional enhanced water processing apparatus 450 is present in the system 400, it may be bypassed by part of the conveyance system 488.

Some or all of the process of separating the one or more solids 467 from the enhanced water 457 may be controlled by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of separating the one or more solids 467 from the enhanced water 457 may be controlled by a user 451.

In step 789, the one or more solids 467 and the enhanced water 457 are evaluated. Some or all of the process of evaluating the one or more solids 467 and the enhanced water 457 may be controlled by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of evaluating the one or more solids 467 and the enhanced water 457 may be controlled by a user 451. Evaluating one or more of the solids 467 and/or the enhanced water 457 may be based on raw measurements made by sensor devices 460, adjusted measurements made by sensor devices 460, outputs of models using measurements made by sensor devices 460 as inputs, some other information associated with measurements made by sensor devices 460, or any suitable combination thereof. Each of the solids 467 and/or the enhanced water 457 may be evaluated at the surface (e.g., surface 108, surface 208).

The results may be evaluated continuously over an extended period of time or on a discrete basis. The results may be evaluated against historical data, other present data, and/or forecasts. The results may be evaluated against data for the particular wellbore 120 from which the water 447 is extracted, for other adjacent wells that are part of the same pad, and/or for other wells (e.g., a SWD well) in other locations. In certain example embodiments, in addition to evaluating the one or more solids 467 and the enhanced water 457, other elements and/or aspects of the wellbore 120 and/or other wells may also be evaluated in this step 789. In any case, the evaluation may be in terms of chemistry, economics (e.g., considering the value of the solids 467 generated, the cost of the additives 427, increased revenue due to improved production/reduced downtime for a field operation 465-2 and/or field operation 465-3, etc.), some other factor, or any suitable combination thereof.

In a specific example, produced gas from a well/field containing elevated levels of CO₂ (e.g., 8% CO₂ as a mole fraction) may cause tubing/casing corrosion when the gas is used as a lift gas. By flowing/purging this produced gas through a NaOH solution, the CO₂ in the gas may be chemically extracted from the gas. The corrosion risk of producers may be significantly reduced due to the CO₂ removal from the lift gas. The Na₂CO₃ solution formed may be used as additive 427 to enhance the water 447. This approach also benefits fracturing operations/refracturing operations by removing CO₂ from the gas and enhancing reused water quality to reduce pore blockage, reduce loss in injection efficiency, reduce loss of sweep efficiency (increased well count), etc. Corroded downhole casing/materials may increase the risk and uncertainty for fracturing operations/refracturing operations and the overall life of a well. This approach may also impact the economics of fracturing operations/refracturing operations in existing wells.

In step 773, a determination is made as to whether the evaluation in step 789 matches the one or more forecasts. The forecasts may be with respect to predicted characteristics of the enhanced water 457, one or more of the solids 467, the wellbore 120, another well (e.g., a SWD well), another aspect of a field operation 465, or any suitable combination thereof. The forecasts may be with respect to in terms of chemistry, economics (e.g., overall, for a specific part of a field operation 465), some other factor, or any suitable combination thereof. Some or all of the determination may be made by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the determination may be made by a user 451. Some or all of the determination may be made at the surface (e.g., surface 108, surface 208). If the evaluation matches the forecasts, then the process proceeds to step 776. If the evaluation does not match the forecasts, then the process proceeds to step 774.

In step 774, one or more of the models (forms of algorithms 533) is adjusted. One or more of the models may be adjusted using the actual data (e.g., measurements by sensor devices 460) and/or differences between actual data and forecasts. For example, a model that calculates and determines the fracturing water chemical package for a field operation 465 may be adjusted. As another example, a model that determines the water specifications for a SWD well may be updated. Some or all of the adjustments to one or more of the models may be made by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the adjustments to one or more of the models may be made by a user 451. A model may be adjusted at the surface (e.g., surface 108, surface 208). When step 774 is complete, the process may revert to step 784.

In step 776, the one or more solids 467 and the enhanced water 457 are distributed to one or more field operations 465-2. The one or more solids 467 and the enhanced water 457 may be distributed to one or more field operations 465 using parts of the conveyance system 488. A field operation 465 may be the same field operation as the field operation 465 in which the water 447 is extracted (if applicable), a different field operation (e.g., a fracturing) as the field operation 465 for the wellbore 120 from which the water 447 is extracted (if applicable), a field operation 465 in the same wellbore or in a different wellbore that shares a pad with the wellbore 120 from which the water 447 is extracted (if applicable), a field operation 465 in a SWD well, or some other field operation 465 (e.g., cementing for construction).

Some or all of the process of distributing the one or more solids 467 and the enhanced water 457 may be controlled by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of distributing the one or more solids 467 and the enhanced water 457 may be controlled by a user 451. The distribution process may be controlled using measurements from one or more sensor devices 460.

In step 777, the one or more solids 467 and the enhanced water 457 are evaluated in their respective field operations 465. Some or all of the process of evaluating the one or more solids 467 and the enhanced water 457 in their respective field operations 465 may be controlled by a controller 404 (or a collecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the process of evaluating the one or more solids 467 and the enhanced water 457 in their respective field operations 465 may be controlled by a user 451. Evaluating one or more of the solids 467 and/or the enhanced water 457 in their respective field operations 465 may be based on raw measurements made by sensor devices 460, adjusted measurements made by sensor devices 460, outputs of models using measurements made by sensor devices 460 as inputs, some other information associated with measurements made by sensor devices 460, or any suitable combination thereof.

The results may be evaluated continuously over an extended period of time or on a discrete basis. The results may be evaluated against historical data, other present data, and/or forecasts. The results may be evaluated against data for the particular wellbore 120 from which the water 447 is extracted, for other adjacent wells that are part of the same pad, for upcoming/future developments, and/or for other wells (e.g., a SWD well) in other locations. In certain example embodiments, in addition to evaluating the one or more solids 467 and the enhanced water 457, other elements and/or aspects of the wellbore 120 and/or other wells may also be evaluated in this step 789. In any case, the evaluation may be in terms of chemistry, the impact on well performance, the impact on field operations 465, overall economics, some other factor, or any suitable combination thereof. Each solid 467 and/or the enhanced water 457 may be evaluated in their respective field operations 465 at the surface (e.g., surface 108, surface 208).

In step 778, a determination is made as to whether the evaluation in step 777 matches the one or more forecasts. The forecasts may be with respect to predicted characteristics of the enhanced water 457, one or more of the solids 467, the wellbore 120, another well (e.g., a SWD well), another aspect of a field operation 465, or any suitable combination thereof during the respective field operation 465. The determination may be made at the surface (e.g., surface 108, surface 208).

The forecasts may be with respect to in terms of chemistry, the impact on well performance, the impact on field operations 465, overall economics, some other factor, or any suitable combination thereof. As some non-exclusive examples, the determination may be made with respect to the economic impacts of hydrocarbon recovery, improved performance of SWD wells, less CO₂ corrosion-induced (or otherwise created) tubing and/or casing failures, lower workovers costs by reducing CO₂ in lift gas, less downtime and cost of fixing fluid compatibility related well failures (e.g., due to scale depositions 213), the costs and revenues of generating calcium carbonate using additives 427 in the form of alkali salts, carbon dioxide, and/or other compounds, and the impact of the economic assessment for future refracturing operations of the wellbore 120.

Some or all of the determination may be made by a controller 404 (or a selecting component thereof) using one or more protocols 532, one or more algorithms 533 (e.g., models), measurements of one or more sensor devices 460, input from a user 451 (which may include an associated user system 455), and/or any other source of information within the system 400. In addition, or in the alternative, some or all of the determination may be made by a user 451. If the evaluation matches the forecasts, then the process proceeds to the END step. If the evaluation does not match the forecasts, then the process reverts to step 774.

During a hydraulic fracturing stage of a subterranean field operation 465, the frac fluid (which includes enhanced water 457) used mixes with the rock (e.g., rock found in the rock matrices 162, rock in the frac face 102) and other waters (e.g., formation water, water from non-targeted formation, completion fluid, or other waters) at the subsurface, followed by the relatively lengthy shut-in stage. This interaction of fluids and solids at the subsurface may generate scale depositions 213 that form on the frac face 102 of the fractures 101, in the rock matrices 162, on the proppant 112, in equipment (e.g., pipes) used in the field operation 465, and/or on other surfaces involved in the field operation 465. As discussed above, when the well is put on production, these scale depositions 213 ultimately accumulate to the point of congesting or stopping paths through which the subterranean resource 111 may be extracted. In this way, the scale depositions 213 may reduce, in some cases dramatically reduce, the productivity of a well. Example embodiments are designed to generate an enhanced water 457 having contents that tend lead to little or no scale deposition 213 development at the subsurface.

The amount of time that the evaluations conducted in this method may be extended (e.g., one month, two months, three months) to simulate a different stage (e.g., a shut-in stage, which occurs after a fracturing stage) of a field operation 465. Further, during this subsequent stage in a field operation 465 at the subsurface, the contents of the water 447 in the near-wellbore formation may change. In such cases, the contents and/or concentrations of the enhanced water 457 may be changed during the extended testing period to simulate subsurface conditions as much as possible.

In addition to the duration of the evaluations performed using this method and adjusting the contents/concentrations of the enhanced water 457, other aspects of the evaluations may additionally or alternatively be controlled. For example, the testing environment may be controlled in terms of the pressure and/or temperature that is asserted on the fluid (which includes the enhanced water 457) used at the subsurface. In addition, or in the alternative, the flow rate of the enhanced water 457 flowing through the rock matrices at the subsurface may be simulated during the evaluations. In such cases, the values of the temperature, the pressure, and/or the flow rate may differ at different points of the duration of the testing, in some cases in an attempt to simulate the hydraulic fracturing and shut-in stages of a subterranean field operation 465-1.

Control of some or all of the testing and evaluations may be performed by a controller 404 (or a testing and evaluation component thereof) using one or more protocols 532, one or more algorithms 533 (e.g., models), measurements of one or more sensor devices 460, input from a user 451 (which may include an associated user system 455), and/or any other source of information within the system 400. In some cases, input for one or more aspects of the testing may be provided (e.g., by a user system 455, by a sensor device 460) to the controller 404. In addition, or in the alternative, control of some or all of the testing may be performed by a user 451 (which may include an associated user system 455), the network manager 480, and/or some other component of the system 400. The duration of the testing (or portions thereof, such as the simulated duration of the hydraulic fracturing stage of a subterranean field operation 465) may be timed by the timer 535 of the controller 404.

In certain example embodiments, multiple tests are performed simultaneously (in parallel with each other). In such cases, each of the multiple tests may be distinguished from the other simultaneous tests by varying one or more of a number of factors, including but not limited to the duration of the test, the composition of the enhanced water 457, the type and/or amount of additives used to interact with the enhanced water 457, and the proportions (amounts or concentrations) of each of the enhanced water 457.

The method set forth in FIG. 7 is configured to use enhanced water 457 having moderate or high amounts of TDSs and low amounts of scale-generating components (e.g., multivalent cations) to enhance recovery of subterranean resources 111 and improve production performance of the wellbore 120. Some theories in the industry hold that fluids having low levels of TDSs (e.g., fresh water, brackish water) promote imbibition and unlock hydrocarbon production from nanopores in certain types (e.g., shale) of subterranean formations 110. In this case, while the TDSs of the enhanced water 457 may be relatively higher, the low amounts of scale-generating components may enhance recovery of subterranean resources 111 and improve production performance of the wellbore 120. Example embodiments may optimize (e.g., through testing and evaluation, as set forth in the method of FIG. 7) the TDSs in the enhanced water 457 for a certain type (e.g., shale) of subterranean formation 110 in which subterranean resources 111 are located.

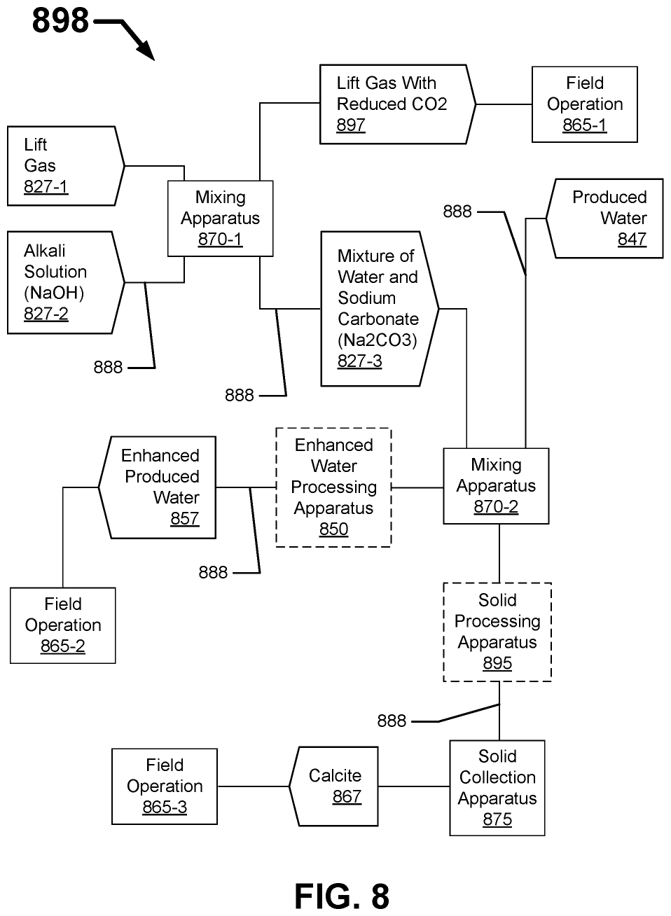

FIG. 8 shows a diagram 898 of a specific application of a process flow for enhancing water chemistry for improved well performance according to certain example embodiments. Referring to FIGS. 1 through 8, the diagram 898 of FIG. 8 shows that the process flow begins with two additives 827, where additive 827-1 is in the form of lift gas and where additive 827-2 is in the form of an alkali solution (e.g., NaOH). The additive 827-1 and the additive 827-2 are conveyed to a mixing apparatus 870-1 using part of a conveyance system 888. When the additive 827-1 and the additive 827-2 are mixed in the mixing apparatus 870-1 (and also potentially further processed in the mixing apparatus 870-1 using functionality that may be found, for example, in the enhanced water processing apparatus 450 and/or the solid processing apparatus 495), the mixing apparatus 870-1 may output one or more compounds.

For example, in this case, the mixing apparatus 870-1 outputs another additive 827-3 in the form of a mixture of water and sodium carbonate, as well as a lift gas with reduced CO₂ 897. The lift gas 897 with reduced CO₂ is a type of enhanced product that may be used in a field operation 865-1 (e.g., enhanced oil recovery from a wellbore). In such a case, the lift gas 897 with reduced CO₂ may provide one or more benefits for the field operation 865-1. Such benefits may include, but are not limited to, less corrosion, improved economics for future refracturing jobs, and a longer useful production life of the well. In an alternative embodiment, an output of the mixing apparatus 870-1 and/or an input to the mixing apparatus 870-2 may be a mixture of water 847 in the form of produced water, the additive 827-3 in the form of the mixture of water and sodium carbonate, the lift gas 897 with reduced CO₂, and/or other hydrocarbon gas.

The additive 827-3 in the form of the mixture of water and sodium carbonate output by the mixing apparatus 870-1 may be used as an input delivered to the mixing apparatus 870-2 by part of the conveyance system 888. In addition, the water 847 (e.g., in the form of produced water) may be delivered to the mixing apparatus 870-2 using part of the conveyance system 888. The water 847, when in the form of produced water, may be extracted from a wellbore 120 and include one or more compounds. In this example, the water 847 is in the form of produced water and includes calcium dichloride (CaCl₂).

The mixing apparatus 870-2 mixes and/or otherwise processes (with or without the use of an optional enhanced water processing apparatus 850 and an optional solid processing apparatus 895) the water 847 and the additive 827-3 in the form of the mixture of water and sodium carbonate 827-3. One output from the mixing apparatus 870-2 in this example, using part of the conveyance system 888, is enhanced produced water 857 (a form of the enhanced water 457 discussed above with respect to FIG. 4), which may be used in a field operation 865-2. In certain example embodiments, an enhanced water process apparatus 850 may be connected to an output of the mixing apparatus 870-2 and include a filtering capability and a capability to add one or more acids. In such a case, the water-based product that is received by the enhanced water process apparatus 850 from the mixing apparatus 870-2 may have a relatively high pH value (e.g., 9, 9.5). After the high pH water-based product is filtered in the enhanced water process apparatus 850, one or more acids (e.g., HCl) may be added to lower the pH value (e.g., 6.5, 7.0) of the resulting enhanced produced water 857. As a result, water saturation toward calcite may change from oversaturation to undersaturation, which eliminates or minimizes solid precipitation in the enhanced produced water 857.

The field operation 865-2 may be injection into an injection (e.g., SWD) well, in which case the enhanced produced water 857 may improve the performance of the injection well because the enhanced produced water 857 lacks or has a reduced amount of calcium relative to the amount of calcium in the water 847 that is in the form of produced water. As an alternative, if the field operation 865-2 is a fracturing job in a wellbore 120, then the enhanced produced water 857, when used as part of the fracturing fluid, may improve the fracturing efficiency and the production performance of the wellbore.

Another output of the mixing apparatus 870-2 in this example is a solid 867 in the form of calcite 867, where the solid 867 is a type of a solid 467 discussed above with respect to FIG. 4. The solid 867 in the form of calcite may include one or more precipitates and/or impurities. The solid 867 in the form of calcite is collected by the solid collection apparatus 475 from the mixing apparatus 870-2 (and optionally the solid processing apparatus 895) using part of the conveyance system 888. The solid 867 in the form of calcite may be used in field operation 865-3, which in this example is construction (e.g., buildings, roads, flooring). In such a case, the solid 867 in the form of calcite may be used as an ingredient in cement.

The following table (Table 1) shows data collected using example embodiments for two different wells located in the same field under the application discussed above with respect to FIG. 8:

TABLE 1

| | | | | | | | | CO2 | CO2 |
|---|---|---|---|---|---|---|---|---|---|
| | | | | | | CO2 | | from | from |
| | Ca | Water | CO2 | CaCO3 | NaOH | conc. | Gas | produced | other |
| | conc. | rate | Rec. | produced | Rec. | In gas | rate | gas | sources |
| | mg/L | BWPD | Ton/D | Ton/D | Ton/D | mol % | MMscf/D | Ton/D | Ton/D |
| Well 1 | 7000 | 20000 | 24.5 | 55.7 | 44.5 | 6.0% | 11 | 33.6 | −9.1 |
| Well 2 | 3500 | 20000 | 12.2 | 27.8 | 22.3 | 0.2% | 25 | 2.5 | 9.7 |

The term “Rec.” in the table above means “recommended”. CO2 from other sources may include one or more of a number of other sources, including but not limited to pure CO2, produced CO2, hydrocarbon combustion, and part of a mixed gas.

As another example, if water 447 is produced water that includes 5000 mg/L of Ca²⁺ and has a volume of 1.5 MM barrels per day, the Ca produced may be approximately 1315 US tons per day, and the resulting CaCO₃ is produced as a solid 467 at approximately 3287 US tons per day. In addition, the CO₂ consumed (including HCO₃/CO₂ in the water 467) is approximately 1446 US tons per day, and the NaOH consumed is approximately 1315 US tons per day. In some cases, NaHCO₃ may be used in place of NaOH.

Examples of some equations that may be used to determine mixing ratios between different streams and other considerations using example embodiments may include, but are not limited to:

CO₂+2NaOH→Na₂CO₃+H₂O (1)

CO₂+NaOH→NaHCO₃ (2)

CaCl2+Na₂CO₃→CaCO₃↓+2NaCl (3)

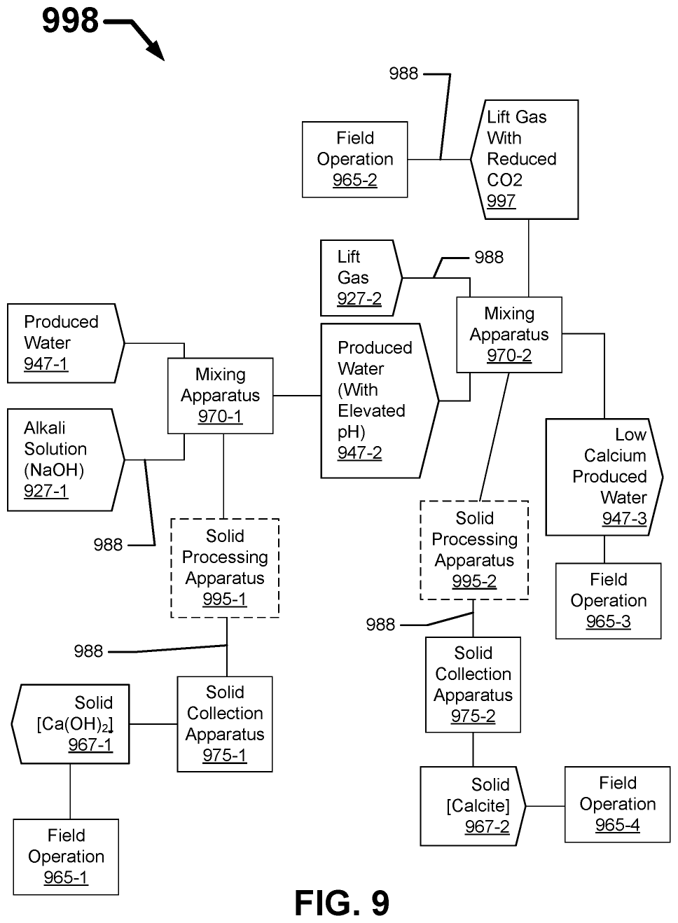

FIG. 9 shows a diagram 998 of another specific application of a process flow for enhancing water chemistry for improved well performance according to certain example embodiments. Referring to FIGS. 1 through 9, the diagram 998 of FIG. 9 shows that the process flow begins with an additive 927-1 in the form of an alkali solution (e.g., NaOH) and water 947-1 in the form of produced water. The water 947-1 in the form of produced water may be extracted from a wellbore 120 and include one or more compounds. In this example, the water 947-1 includes calcium (e.g., 13000 ppm). The additive 927-1 and the water 947-1 are conveyed to a mixing apparatus 970-1 using part of a conveyance system 988. 60 This case is configured to remove some or all of the calcium from the water 947-1, and a 2-step process is used. The first step, with the use of mixing apparatus 970-1, is to raise the pH of the water 947-1 so that in the second step, with the use of mixing apparatus 970-2, the additive 927-2 may more effectively precipitate out the calcium.

When the water 947-1 and the additive 927-2 are mixed in the mixing apparatus 970-1 (and also potentially further processed in the mixing apparatus 970-1 using functionality that may be found, for example, in the enhanced water processing apparatus 450 and/or the solid processing apparatus 495), the mixing apparatus 970-1 may output one or more compounds. For example, in this case, the NaOH in the alkali solution of the additive 927-1 precipitates out Ca²⁺ from the water 947-1 in the form of produced water to form Ca(OH)₂ (i.e., calcium hydroxide) as a solid 967-1 and water 947-2 in the form of produced water with elevated pH (e.g., a pH of 12.0, a pH of 10.5). As a result, the mixing apparatus 970-1 outputs the water 947-2 in the form of produced water with elevated pH and the solid 967-1 in the form of calcium hydroxide. An example of this reaction in the mixing apparatus 970-1 may be:

2NaOH+Ca²⁺=Ca(OH)₂↓+2Na⁺

The solid 967-1 output by the mixing apparatus 970-1 may be conveyed, using part of the conveyance system 988, to a solid collection apparatus 975-1 (via an optional solid processing apparatus 995-1). From there, the solid 967-1 may be used in a field operation 965-1, such as Ca(OH)₂ (also called slaked lime). Slaked lime may be used in lime muds and as a treatment to remove carbonate ions. Slaked lime may be used as a stabilizing ingredient in oil- and synthetic-based mud, used in the formation of fatty-acid soap emulsifiers. Slaked lime may be an alkaline material that may be carried in excess to neutralize hydrogen sulfide (H₂S) and carbon dioxide (CO₂).

The water 947-2 in the form of produced water with elevated pH that is output by the mixing apparatus 970-1 may be conveyed, using part of the conveyance system 988, to another mixing apparatus 970-2, where the water 947-2 becomes an input to the mixing apparatus 970-2. Another input to the mixing apparatus 970-2 in this case is an additive 927-2 in the form of a lift gas that includes CO₂. When the water 947-2 and the additive 927-2 are combined in the mixing apparatus 970-2 in this example, the CO₂ from the additive 927-2 is bubbled into the water 947-2 with the elevated pH to form CO₃²⁻ in the water 947-2. The CO₃²⁻ then precipitates with the residual Ca²⁺ to reduce the pH in the water 947-2. An example of the reaction in the mixing apparatus 970-2 may be: CO₂+2OH⁻+Ca²⁺=CaCO₃↓+H₂O. This may reduce the pH of the water 947-2 from, for example, 11.0 to 7.5. In other examples, the pH of the water 947-2 may be reduced from 13.0 to 7.0, from 12.0 to 8.0, and from 13.5 to 4.0.

In this example, the reaction in the mixing apparatus 970-2 yields three outputs. Specifically, the mixing apparatus 970-2 outputs a lift gas 997 with reduced CO₂, a solid 967-2 in the form of calcite (CaCO₃), and water 947-3 in the form of low calcium produced water. The lift gas 997 with reduced CO₂ that is output by the mixing apparatus 970-2 may be a type of enhanced product that may be conveyed to a field operation 965-2 (e.g., enhanced oil recovery from a wellbore) using part of the conveyance system 988. In such a case, the lift gas 997 with reduced CO₂ may provide one or more benefits for the field operation 965-2. Such benefits may include, but are not limited to, less corrosion, improved economics for future refracturing jobs, and a longer useful production life of the well.

The water 947-3 in the form of produced water with low calcium that is output by the mixing apparatus 970-2 may be conveyed to another field operation 965-3 using part of the conveyance system 988. The water 947-3 in the form of produced water with low calcium may significantly reduce the scaling potential (e.g., the formation of carbonate scales, which is a major scale often encountered during field operations). The water 947-3 should have a pH that is lower than the pH of the water 947-2 since the additive 927-2 in the form of lift gas bubbles through the water 947-2. The additive 927-2 in the form of a lift gas (e.g., CO₂) will react with calcium in the water 947-2 at elevated pH levels. Subsequently, the pH of the water 947-3 is decreased due to the reaction and presence of CO₂ in the system. This process removes Ca by precipitating out CaCO₃, and also lowers the pH of the water 947-3 relative to the pH of the water 947-2 to reduce carbonate scaling tendency in the water 947-3. The water 947-3 may be similar to the enhanced produced water 857 of FIG. 8, but in this case the water 947-3 has a relatively lower pH value, which means that the water 947-3 also has relatively less carbonate scaling tendency during field operations.

The solid 967-2 in the form of calcite (CaCO₃) that is output by the mixing apparatus 970-2 may be conveyed, using part of the conveyance system 988, to a solid collection apparatus 975-2 (via an optional solid processing apparatus 995-2). From there, the solid 967-2 may be used in a field operation 965-4 which in this example may be construction (e.g., buildings, roads, flooring). The calcite in the solid 967-2 may include one or more precipitates and/or impurities. In such a case, the calcite 867 may be used as an ingredient in cement.

In a lab, the above process was replicated by performing the following steps:
1. Filter the produced water 947-1 by vacuum filtration (using 0.45 μm filter paper) to get rid of yellow rust from Fe3+ precipitation.
2. Use 30% NaOH as an additive 927-1 to raise the pH of the water 947-1 to >12, providing an excess amount of NaOH to precipitate out Ca in the water 947-1. The pH was raised gradually in eleven 1 ml increments, as shown in the table (Table 2) below:

TABLE 2

| INCREMENT | ADDITIVE 927-1 | pH |
|---|---|---|
| 0 | 0 | 6.78 |
| 1 | +1 mL 30% NaOH | 9.83 |
| 2 | +1 mL 30% NaOH | 10.25 |
| 3 | +1 mL 30% NaOH | 11.81 |
| 4 | +1 mL 30% NaOH | 11.87 |
| 5 | +1 mL 30% NaOH | 11.93 |
| 6 | +1 mL 30% NaOH | 12.02 |
| 7 | +1 mL 30% NaOH | 12.10 |
| 8 | +1 mL 30% NaOH | 12.18 |
| 9 | +1 mL 30% NaOH | 12.34 |
| 10 | +1 mL 30% NaOH | 12.61 |
| 11 | +1 mL 30% NaOH | 12.85 |
| Total 30% NaOH | 11 mL | |

3. Use a vacuum to filter out the solids and get a clear solution.
4. Bubble CO₂ (additive 927-2 in the form of a lift gas with CO₂) into the clear solution (water 947-2 in the form of produced water with elevated pH). As a result, a white solid precipitation (solid 967-2 in the form of calcite) forms, and the pH of the clear solution (water 947-3 in the form of produced water with low calcium) is lowered. Continue bubbling the CO₂ until the pH falls below 8.5 (e.g., pH of 8.28).
5. Titrate the Ca. In this example, the titration level of the water 947-3 before introducing the additive 927-2 is 16,000 ppm Ca, the titration level of the water 947-3 after PPT is 340 ppm Ca, and the titration level of the water 947-3 after completing the interaction with the additive 927-2 is 0 ppm Ca.

As another practical example of evaluating and optimizing frac water sourcing used in a subterranean field operation to improve well performance over multiple stages, samples may be taken from multiple wells. Chemistry of water (e.g., water 447) in the form of produced water taken from a wellbore, without any treatment, may have total dissolved solids of 50,000 ppm to 200,000 ppm. Also, such untreated produced water may have dissolved ion concentration ranges of 1,000 ppm Ca to 15,000 ppm Ca, of 100 ppm Mg to 4,000 ppm Mg, of 100 ppm Sr to 2,000 ppm Sr, etc. For example, a specific sample of untreated produced water may include 50,000 ppm of Na, 100,000 ppm of Cl, 10,000 ppm of Ca, 3,000 ppm of Mg, 1,000 ppm of Sr, 1,000 ppm of K, 1,000 ppm of Br, 200 ppm of SO₄, 4 ppm of Fe, 17 ppm of Li, and 7 ppm of Si.

Induced or otherwise created solids produced using example embodiments may show expected high purity and high levels of Ca, Mg, and Sr elements through analysis using quantitative x-ray diffraction (QXRD) and energy-dispersive spectroscopy (EDS). The following tables show solid production using example embodiments for three different samples of produced water in terms of weight (Table 3) and percentage (Table 4). These tests are performed at the surface (e.g., in a lab). Each reaction is over time relative to the original sample.

TABLE 3

| Solid Production | Reaction 1 | Reaction 2 | Reaction 3 |
|---|---|---|---|
| Molar ratio of Na₂CO₃ to Ca + Mg | 0.45 | 1.2 | 2.2 |
| Total solid (mg) | 760 | 1680 | 1760 |
| Ca in solids from QXRD (mg) | 290 | 600 | 640 |
| Ca water chemistry change (mg) | 190 | 590 | 650 |
| Mg in solids from QXRD (mg) | 5 | 48 | 48 |
| Mg water chemistry change (mg) | 26 | 80 | 100 |

TABLE 4

| Element (weight %) | Reaction 1 | Reaction 2 | Reaction 3 |
|---|---|---|---|
| O | 49.7 | 50.0 | 49.5 |
| Ca | 32.8 | 29.8 | 23.8 |
| C | 12.9 | 13.9 | 19.4 |
| Sr | 2.0 | 2.6 | 2.7 |
| Mg | 1.4 | 2.1 | 2.3 |
| Na | 1.0 | 1.4 | 2.0 |
| Cl | 0.1 | 0.2 | 0.3 |
| S | 0.1 | 0 | 0 |

Additives (e.g., additives 427) that are mixed (e.g., using a mixing apparatus 470) with untreated produced water may change (e.g., increase) the pH of the produced water and cause increased masses of induced or otherwise created solids precipitation up to some threshold value (e.g., a theoretical maximum). The following table (Table 4) is for a series of sample from a site and validate the carbonate precipitation reactions using example embodiments. In this case, the solids from the produced water (in lbs/bbl) and the volume ratio of additive to produced water has a linear relationship until the last line of Table 5. The solids produced may be white or colored, depending on the quality of the water. These tests are performed at the surface (e.g., in a lab).

TABLE 5

| | | | Total projected |
|---|---|---|---|
| Volume ratio of additive | Molar ratio of | Solids | solids |
| to produced water | Na₂CO₃ to Ca + Mg | (lbs/bbl) | (Tons/D) |
| 0.00 | 0.00 | 0.0 | 0.0 |
| 0.02 | 0.11 | 1.2 | 12.2 |
| 0.04 | 0.21 | 2.7 | 27.0 |
| 0.06 | 0.33 | 4.3 | 42.5 |
| 0.09 | 0.45 | 5.8 | 57.9 |
| 0.23 | 1.19 | 14.5 | 144.9 |
| 0.43 | 2.21 | 17.6 | 176.3 |

Changes to produced water chemistry before and after additive reactions using example embodiments may be seen in concentrations of Ca, Mg, and Sr, with possible changes in concentration of Mn, Zn, Fe, Al, and Ba. Changes in concentration of Li and K may be likely due to dilution effects. The following table (Table 6) is illustrative. These tests are performed at the surface (e.g., in a lab). Each reaction is over time relative to the original sample.

TABLE 6

| | | Reaction | Reaction | Reaction | Reaction | Reaction | Reaction |
|---|---|---|---|---|---|---|---|
| Metric | Original | 1 | 2 | 3 | 4 | 5 | 6 |
| Molar | | 0.11 | 0.21 | 0.33 | 0.45 | 1.2 | 2.2 |
| ratio of | | | | | | | |
| CO₃ to | | | | | | | |
| Ca + Mg | | | | | | | |
| Na | 57000 | 54000 | 55000 | 59300 | 61600 | 60200 | 62800 |
| Ca | 13000 | 13000 | 12600 | 11600 | 10100 | 1400 | <100 |
| Mg | 2400 | 2440 | 2310 | 2170 | 2040 | 890 | 407 |
| Mn | 3.0 | 3.3 | 3.3 | 3.1 | 2.9 | 0.1 | 0.2 |
| Sr | 1500 | 1490 | 1380 | 1280 | 1230 | 230 | 4.7 |
| Zn | >30 | 13.9 | 2.9 | 0.6 | 0.3 | <0.1 | 0.8 |
| K | 1130 | 1170 | 1160 | 1130 | 967 | 966 | 837 |
| Fe | 3.5 | 0.6 | 0.4 | 0.6 | <0.2 | <0.2 | <0.2 |
| Li | 20.0 | 21.1 | 20.9 | 20.4 | 22.3 | 17.5 | 14.3 |
| Al | >30 | 33.0 | 8.97 | 3.87 | 1.36 | 1.95 | 1.83 |
| Ba | 8.0 | 9.2 | 8.6 | 7.9 | 7.3 | 1.0 | 0.4 |
| Dilution | | 0.98 | 0.96 | 0.94 | 0.92 | 0.81 | 0.7 |
| Factor | | | | | | | |

Certain analyses, such as a laser particle size analysis (LPSA), may be used to evaluate solids that are generated using example embodiments. For example, an analysis may be performed on enhanced solid generation, settling/aggregation speed, and removal ability though optimization of alkaline, coagulant, and flocculant additives. The following table (Table 7) provides a summary of results of such analysis. These analyses are performed at the surface (e.g., in a lab).

TABLE 7

| | | Mean | Max | | | |
|---|---|---|---|---|---|---|
| | Ratio | particle | particle | | Solids | |
| | of CO₃ to | size | size | Additives | settling | |
| Experiment | Ca + Mg | (μm) | (μm) | Used | time | |
| Exp 1 | 2.5 | 3.4 | 25 | Alkaline | >4 | hours |
| (Dispersed | | | | additive | | |
| Solids) | | | | | | |
| Exp 2 | 0.2 | 90 | 350 | Alkaline | >4 | hours |
| (Standard | | | | additive | | |
| Solids) | | | | | | |
| Exp 3 | 2.2 | 151 | 500 | Alkaline | 5 | minutes |
| (Flocculated | | | | additive | | |
| Solids) | | | | Flocculant 1 | | |
| Exp 4 | 2.2 | 306 | 600 | Alkaline | 1 | minute |
| (Flocculated | | | | additive | | |
| Solids) | | | | Flocculant 2 | | |

The benefits of this testing and evaluation using example embodiments may include, but is not limited to, preventing or reducing injection well plugging, utilization and reduction of CO₂, improved performance of the SWD well, improved fracturing efficiency, enhanced oil recovery, improved well performance using enhanced water chemistry for fracturing and well workover, generating calcite as a product of removing Ca from produced water, reducing CO₂ in lift gas, reducing corrosion risk induced or otherwise created by CO₂, reducing pore blockage, reducing loss in injection efficiency, reducing loss of sweep efficiency (increased well count), reducing operational costs (e.g., by avoiding corrosion issues), improving future economics for refracturing operations, etc.

Example embodiments may be used to provide systems and methods for evaluating and optimizing frac water sourcing used in a subterranean field operation to improve well performance over multiple stages (e.g., fracturing, shut-in, production). Example embodiments include the performance of multiple first phase tests that identify a baseline or minimum amount (concentration) of a scale inhibitor in a fluid (e.g., a frac fluid) that may eliminate scale depositions when the fluid is mixed with an additional fluid (e.g., formation water). Example embodiments also include performance of one or more second phase tests that mix the two fluids from the first phase test (albeit with higher initial amounts of scale inhibitor in the first fluid) with rock. When the concentration of scale inhibitor in aqueous form at the end of the second phase test is substantially equal to the minimum concentration of scale inhibitor in the first phase test, then the amount of scale inhibitor used to start the second phase test is the target concentration of the scale inhibitor to be used in frac water of a subterranean field operation.

Example embodiments may be used to generate, evaluate, and/or optimize enhanced water chemistry by mixing water with one or more additives. The resulting enhanced water may be used to improve performance during subsurface field operations such as fracturing and injection of SWD wells. Example embodiments may also generate one or more solids that may be used in the same or another field operation. Example embodiments may be fully or partially automated. Using example embodiments, tests and evaluations may be conducted in which enhanced water is subjected to conditions that are representative of those of a fractured subterranean formation. Example embodiments may provide a number of benefits. Such benefits may include, but are not limited to, preventing/reducing scale/solid deposition at the subsurface (e.g., in fractures, on frac face, in pore throat), optimizing well performance, enhancing oil recovery, ease of use, extending the life of a well (including both producer and injector), reducing damage (e.g., caused by scale/solid deposition) to field equipment, creation of by products that may be used for other purposes, flexibility, configurability, and compliance with applicable industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for enhancing water chemistry at a surface for improved well performance, the method comprising:
testing water at the surface to identify a pH level of the water, a type of solid-generating component in the water, and an amount of a solid-generating component in the water;
identifying a type and an amount of an additive based on identifying the type and the amount of the solid-generating component, wherein the additive is configured to generate a solid when mixed with the water; and
mixing, at the surface, the water and the additive to generate the solid and enhanced water, wherein the solid comprises at least some of the solid-generating components of the water,
wherein the enhanced water is usable for a field operation to cause the improved well performance, wherein the enhanced water comprises a reduced amount of solid-generating components relative to the water, and wherein the solid is removable from the enhanced water at the surface.

2. The method of claim 1, further comprising:
removing the solid from the enhanced water.

3. The method of claim 2, further comprising:
filtering the enhanced water after the solid is removed.

4. The method of claim 1, wherein the solid-generating components comprise at least one of a group consisting of dissolved cations, multi-valent cations, and dissolved anions.

5. The method of claim 4, wherein the multi-valent cations comprise calcium, and wherein the solid comprises calcium carbonate.

6. The method of claim 1, wherein the additive comprises at least one of a group consisting of carbon dioxide and an alkali salt.

7. The method of claim 1, wherein the solid is usable for a separate process, wherein the separate process comprises at least one of a group consisting of construction material, concrete, acid neutralization, soil treatment, color enhancement, and flooring material.

8. The method of claim 1, further comprising:
testing the enhanced water at the surface;
evaluating results of testing the enhanced water against expected results; and
adjusting at least one model when the results of the testing substantially deviate from the expected results.

9. The method of claim 1, wherein the enhanced water is tested at the surface under subsurface conditions.

10. The method of claim 1, wherein the enhanced water is tested at the surface by interacting the enhanced water with formation water and rock found in the subterranean formation.

11. The method of claim 1, wherein mixing the water and the additive reduces an amount of total dissolved solids in the enhanced water relative to the water.

12. The method of claim 1, further comprising:
testing the solid at the surface; and
evaluating results of testing the solid against historical data.

13. The method of claim 1, further comprising:
testing the enhanced water at the surface to identify the pH level of the enhanced water and the amount of a solid-generating component in the enhanced water; and
identifying a type and an amount of an additional additive based on identifying the pH level and the amount of the solid-generating component in the enhanced water; and
mixing, at the surface, the enhanced water and the additional additive to generate a second solid and a second enhanced water, wherein the second solid comprises at least some of the solid-generating components of the enhanced water.

14. The method of claim 1, wherein mixing the water and the additive occurs in multiple stages and results in the water having reduced calcium and the solid comprising calcite.

15. A system for enhancing water chemistry for improved well performance, the system comprising:
a water source comprising water;
an additive source comprising an additive, wherein the additive is configured to generate a solid when mixed with the water;
a plurality of sensor devices configured to measure, at a surface, a pH level of the water, a type of solid-generating component in the water, and an amount of a solid-generating component in the water; and
a mixing apparatus that is configured to:
receive the water and the additive at the surface, wherein the additive is of a type and an amount based on identifying the type and the amount of the solid-generating component in the water;
mix the water and the additive at the surface to generate the solid and enhanced water, wherein the solid comprises at least some solid-generating components of the water, wherein the enhanced water is usable for a field operation to cause the improved well performance, wherein the enhanced water comprises a reduced amount of solid-generating components relative to the water, and wherein the solid is removable from the enhanced water; and
provide access to the solid and the enhanced water.

16. The system of claim 15, further comprising:
a controller communicably coupled to the plurality of sensor devices, wherein the controller is configured to identify, using measurements made by the plurality of sensor devices, a recommended mixture of the water and the additive that reduces the solid-generating components.

17. The system of claim 15, further comprising:
an enhanced water processing apparatus configured to process the enhanced water.

18. The system of claim 15, further comprising:
a solid collection apparatus configured to receive the solid.

19. The system of claim 18, further comprising:
a solid processing apparatus positioned between the mixing apparatus and the solid collection apparatus, wherein the solid processing apparatus is configured to process the solid.

20. The system of claim 15, further comprising:
a delivery apparatus configured to deliver the water and the additive to the mixing apparatus.
